(19) United States
(12) Patent Application Publication
(10) Pub. No.: US 2006/0274370 A1
(43) Pub. Date: Dec. 7, 2006

(54) Control technology used in distributed printing for printing control device and printer

(75) Inventor: Toshihiro Shima, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/445,395

(22) Filed: Jun. 2, 2006

(30) Foreign Application Priority Data
Jun. 3, 2005 (JP) 2005-163607
Jun. 21, 2005 (JP) 2005-180236

(51) Int. Cl. G06F 3/12

(52) U.S. Cl. 358/1.15

(57) ABSTRACT

To achieve a smooth distributed printing process, the printer includes a communication module, a job receiving module and a print executing module. The communication module maintains connections to perform communication using a connection-type protocol. The job receiving module receives print jobs through the connections. The number of the print jobs that can be received in parallel is M. The M is a natural number. The print executing module executes printing processes in parallel for the received print jobs. The number of connections that can be maintained simultaneously by the communication module is set to be less than the M.

### CROSS REFERENCE TO RELATED APPLICATIONS

This application relates to and claims priority from Japanese Patent Applications No. 2005-163607, filed on Jun. 3, 2005 and No. 2005-180236, filed on Jun. 21, 2005, the entire disclosure of which is incorporated by reference.

### BACKGROUND

1. Technical Field

The present invention relates to control technology used in distributed printing for printing control device and printer.

2. Description of the Related Art

There are known distributed printing system wherein printing control devices that are connected to a plurality of printers distribute print jobs to the plurality of printers. In this technology it is possible to complete the printing of multiple copies in a short amount of time through allocating the number of copies to be printed to a plurality of printers and performing the printing in parallel.

In this type of distributed printing system, there is a method wherein a print job is divided into a plurality of packets and distributed. In this distribution method, the printing control device distributes print job by repetitively executing, for each packet, the process of distributing the packet to a plurality of distribution destination printers. In this distribution method, for example, when the printing control device receives the print job from client computer through a network and distributes, the printing control device is able to distribute the print job even in cases wherein the capacity of the buffer memory equipped in the printing control device is too small to receive the entire print job from the client computer all at once.

However, when the distribution method described above is used, there is the risk that the distribution destination printer may interfere with the smooth execution of the distributed printing. For example, while a printer may be able to maintain a plurality of simultaneous connections for receiving print jobs, if the printer is capable of processing only one print job at a time, then, typically, that printer would receive print job in turn from the connections established in advance, and will receive the next print job from the next established connection after completing receiving of the print job in advance. When such printers are used as distribution destination printers, the distribution method described above is used and a packet is sent to a connection that is waiting for its turn, the distributed processing necessarily stops until that packet is received.

In particular, when a plurality of printing control devices distribute print job respectively using the distribution method described above to same printers as distribution destinations, the distributed processing may come to a stop all together.

### SUMMARY

An advantage of some aspects of the invention is to provide a smooth distributed printing process.

A first aspect of the invention provides a printing control device capable of sending print jobs to at least two distribution destination printers respectively. The distribution destination printers respectively have a printing module, a first communication module and a job receiving module. The printing module executes the printing in accordance with a provided print job. The first communication module performs communication using a connection-type protocol, wherein the first communication module is capable of maintaining simultaneously a plurality of the connections for the communication. The job receiving module receives the print job through the connection to provide the received print job to the printing module. The connections from which the job receiving module is able to receive data in parallel is less than the connections that the first communication module is able to maintain simultaneously. The job receiving module receives with priority data that is sent through the connection that was established in advance when the first communication module maintains the connections in excess of a receivable number in parallel. The printing control device pertaining to the first aspect of the invention comprises a second communication module, a status determining module and a job sending module. The second communication module establishes the connections with each of the first communication modules of the at least two distribution destination printers. The status determining module determines whether each of the job receiving modules of the at least two distribution destination printers is in a receiving-capable state in which the job receiving modules is immediately able to receive data sent through the connection established by the second communication module. The job sending module transmits the print job to the distribution destination printer having the job receiving module being determined to be in a receiving-capable state.

According to the printing control device pertaining to the first aspect of the invention, the print job is sent after determining that the job receiving module of the distribution destination printer is in a state capable of immediately receiving the print job, thus making it possible to avoid the printing control device going into a waiting state, making it possible to achieve smooth distributed printing.

In the printing control device pertaining to the first aspect, the job sending module may divide the print job into a plurality of packets and may repetitively execute, for each of the divided packets, packet distribution. The packet distribution is sending one of the packets to the respective at least two distribution destination printers to send the print job to the respective at least two distribution destination printers. In distributed printing wherein packet distribution is repeated to send the print job, there is the possibility that deadlock will occur wherein the distributed printing process will stop entirely (where deadlock will be described in detail below). In this case, the printing control device is possible to prevent the distributed printing system from such a deadlock.

The second aspect of the invention provides a printer. The printer pertaining to the second aspect of the invention comprises a communication module, a job receiving module and a print executing module. The communication module maintains connections to perform communication using a connection-type protocol. The job receiving module receives print jobs through the connections. The number of the print jobs that can be received in parallel is M. The M is a natural number. The print executing module executes printing processes in parallel for the received print jobs. The number of connections that can be maintained simultaneously by the communication module is set to be less than the M.

According to the printer pertaining to the second aspect of the invention, the printer maintains no more connections than M that is the number of print jobs receivable in parallel. Thus, the printer may not make the device that sends the print jobs through the connections put into a waiting state. In particular, when used as a distribution destination printer, the printer is able to insure that the distributed printing process proceeds smoothly.

In the printer pertaining to the second aspect, the printer may be connected to a printing control device capable of sending at least one of the print jobs to at least two distribution destination printers respectively. The printing control device may divide the at least one of the print jobs into a plurality of packets and repetitively executes, for each of the divided packets, packet distribution. The packet distribution is sending one of the packets to the respective at least two distribution destination printers to send the print job to the respective at least two distribution destination printers. The printer used as one of the distribution destination printers. In this case, the printer makes it possible to prevent the distributed printing system from the deadlock that may occur in distributed printing processes in this type of printing control device.

The first aspect of the invention may be configured as a printer that houses the printing control device, rather than the configuration as a printing control device described above. Moreover, the configuration of the first aspect is not limited to this type of device invention form, but rather may also be embodied as a method invention, such as a method of sending print jobs. Furthermore, the second aspect of the present invention may also be embodied as a method invention, such as a printing method, instead of configuration as the printer described above. Furthermore, the present invention can be embodied in a variety of ways, such as in the form of a computer program for structuring the method or device described above. Furthermore the invention may also be realized in aspects such as a computer program for accomplishing the functions of the aforementioned apparatus or method, a recording medium having the computer program recorded thereon and data signals in which such a program is realized in a carrier wave.

The above and other objects, characterizing features, aspects and advantages of the invention will be clear from the description of preferred embodiments presented below along with the attached figures.

### BRIEF DESCRIPTION OF THE DRAWINGS

FIG. 1 schematically shows a configuration of a distributed printing system according to a first embodiment;

FIG. 2 shows a block diagram of the internal structure of each device in a distributed printing system according to the first embodiment;

FIGS. 3A-C show schematics for explaining the reception of normal print jobs;

FIG. 4 shows a first flowchart illustrating a processing routine of a distributed printing process according to the first embodiment;

FIGS. 5A-C show schematics for explaining the print job data;

FIG. 6 shows a flowchart illustrating a processing routine in a distribution destination selecting process;

FIG. 7 shows one example of a communications sequence in the divided mode according to the first embodiment;

FIG. 8 shows a second flowchart illustrating a processing routine in a distributed printing process according to the first embodiment;

FIG. 9 shows one example of a communications sequence in the copy mode according to the first embodiment;

FIG. 10 shows a one example of a communications sequence wherein a print job is sent;

FIG. 11 shows a communications sequence when deadlock occurs;

FIGS. 12A-B show diagrams illustrating schematically a case wherein deadlock occurs;

FIG. 13 shows a block diagram of the internal structures of each device in a distributed printing system according to a second embodiment;

FIG. 14 shows a flowchart illustrating a processing routine for an exclusive use scheduling process;

FIG. 15 shows a flowchart illustrating a processing routine for an exclusive use control process;

FIG. 16 shows a flowchart illustrating a processing routine for an exclusive use releasing process;

FIG. 17 shows a first flowchart illustrating a distributed printing processing routine according to the second embodiment;

FIG. 18 shows one example of a communications sequence in the divided mode according to the second embodiment;

FIG. 19 shows a second flowchart illustrating a distributed printing processing routine according to the second embodiment;

FIG. 20 shows one example of a communications sequence in the copy mode according to the second embodiment;

FIG. 21 schematically shows a configuration of a distributed printing system according to a third embodiment;

FIG. 22 shows a block diagram of the internal structure of each device that structures a distributed printing system according to the third embodiment;

FIG. 23 shows a flowchart illustrating a processing routine for a distributed printing process according to the third embodiment;

FIG. 24 shows a flowchart illustrating a processing routine for a connection establishing process according to the third embodiment;

FIG. 25 shows a first flowchart illustrating a processing routine for a printing process according to the third embodiment;

FIG. 26 shows a second flowchart illustrating a processing routine for a printing process according to the third embodiment;

FIG. 27 shows a diagram illustrating schematically the situation wherein a plurality of printing processes is executed in parallel.

### DETAILED DESCRIPTION OF THE PREFERRED EMBODIMENTS

Embodiments of the present invention will be described below with reference to the drawings.

### A. First embodiment:

Structure of a Distributed Printing System:

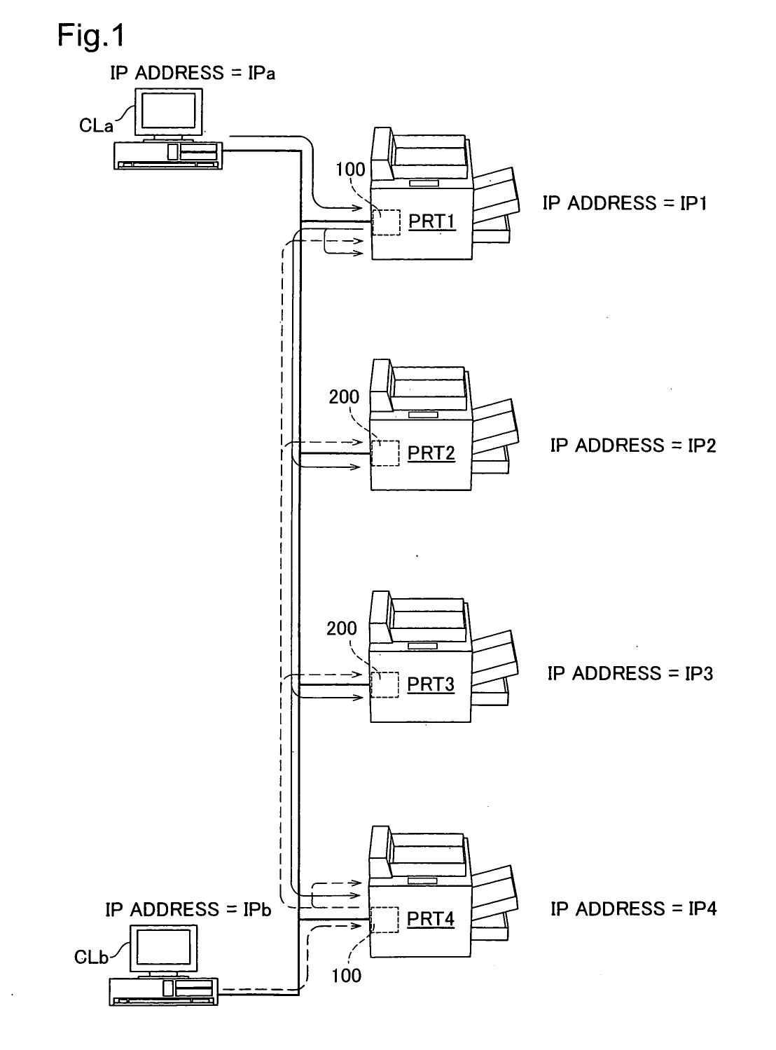

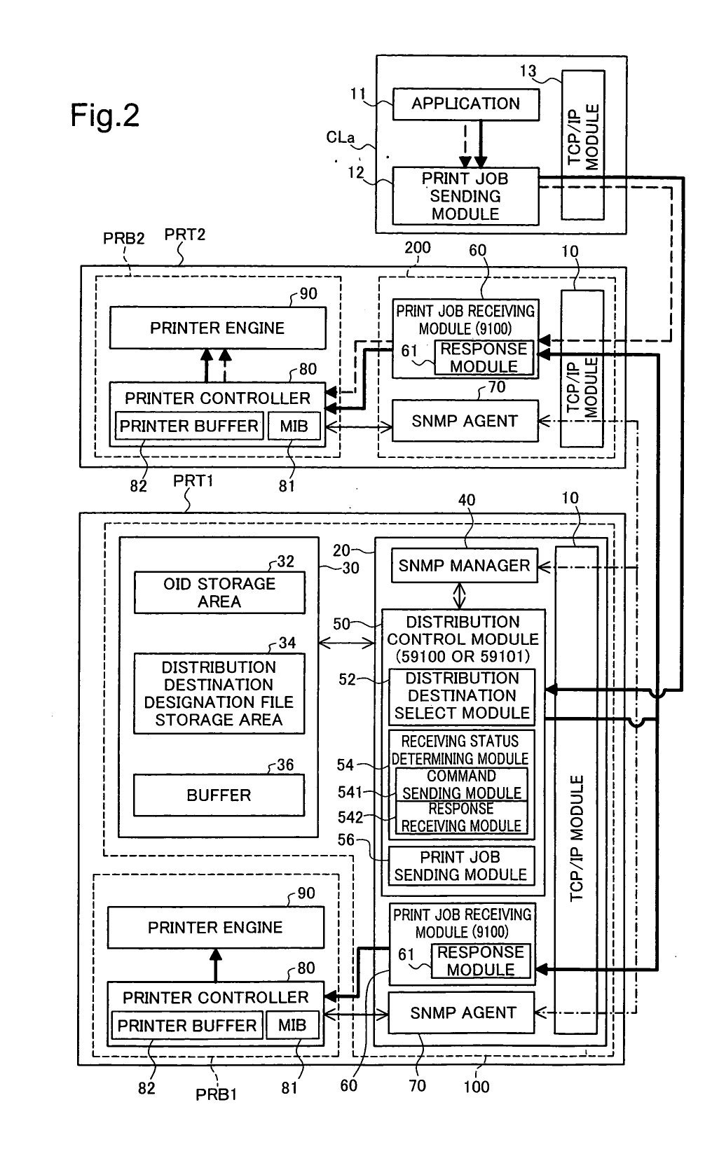

A configuration of a distributed printing system according to a first embodiment according to the present invention will be described referencing FIG. 1 and FIG. 2. FIG. 1 schematically shows a configuration of a distributed printing system according to a first embodiment. FIG. 2 shows a block diagram of the internal structure of each device in a distributed printing system according to the first embodiment.

This distributed printing system, as shown in FIG. 1, includes a plurality of computers as clients (hereinafter termed simply “client”) CLa and CLb, and a plurality of printers PRT1 through PRT4. The clients CLa and CLb are connected via a local area network (LAN) to printers PRT1 through PRT4. Communications between each of the devices is performed using the TCP-IP protocol, and this IP addresses are assigned to each of the devices. For convenience in explanation, it is here assumed that the IP addresses assigned to the clients CLa and CLb are, respectively, “IPa” and “IPb” and that the IP addresses assigned to each of the printers PRT1 through PRT4 are, respectively “IP1” through “IP4.” Note that, strictly speaking, these IP addresses are not set for the clients CLa and CLb or the printers PRT1 through PRT4, but rather are set at nodes in the TCP/IP network (for example, network boards connected to the network for TCP/IP communication).

Of these printers, printers PRT1 and PRT4 are each equipped with a custom network board 100. The custom network board 100 includes a distributed printing control function for executing distributed printing through distributing to other printers the print jobs received from the clients CLa and CLb and the custom network board 100 in this embodiment is equivalent to the printing control device in the claim 1. Printers PRT2 and PRT3 are each provided with a standard network board 200.

In FIG. 1, the arrows shown with the solid lines indicate, schematically, that a print job is sent from the client CLa to the custom network board 100 of the printer PRT1, and the print job is distributed from the custom network board 100 of the printer PRT1 to the printers PRT1 through PRT4. The arrows shown with the dotted lines indicate, schematically, that a print job is sent from the client CLb to the custom network board 100 of the printer PRT4, and the print job is distributed from the custom network board 100 of the printer PRT4 to the printers PRT1 through PRT4. In this way, the printers PRT1 through PRT4 can be used as distribution destinations for distributed printing from either the custom network board 100 of the printer PRT1 or the custom network board 100 of the printer PRT4. In the below, when it is not necessary to discriminate between each of the printers PRT1 through PRT4, the number at the end of the code may be omitted to refer to a printer “PRT”. Moreover, when it is not necessary to discriminate between the clients CLa and CLb, the lower case letter at the end of the code may be omitted to refer to a client “CL.”

The printer PRT1, as shown in FIG. 2, is provided with a printer body PRB1 and the custom network board 100, described above. The printer body PRB1 includes a printer engine 90 and a printer controller 80. The printer engine 90 has a mechanism that performs the actual printing. The printer controller 80 receives print job data that is provided from a print job receiving module 60, described below, and interprets the print job to control the printer engine 90 to execute the printing. The printer controller 80 is able to send to the print job receiving module 60 the necessary response when there is a command requiring a response included in the print job (such as the determining command, described below). The printer controller 80 cannot process multiple print jobs in parallel, but rather can accept and process print jobs only one at a time. The printer controller 80 is provided with a printer buffer 82 that stores, temporarily, the provided print job data. Moreover, the printer controller 80 stores a MIB file 81 in a format known as an MIB (Management Information Base), wherein a variety of information regarding the printer body PRB1 is stored. In the MIB file 81, variety of information is stored in object units, where an object ID (hereinafter termed the “OID”) is assigned to each object.

The custom network board 100 is provided, primarily, with a central processing unit (CPU) 20 and a memory 30. Additionally, the custom network board 100 is also provided with, for example, a communications interface for performing the actual network communications, etc., but explanations thereof will be omitted for convenience.

The CPU 20 reads out programs, such as software to perform the distributed printing described above, from the memory 30, and executes the programs, thereby achieving in software the various functional blocks shown in the figure. Note that these various functional blocks may alternatively be structured in hardware.

The functional blocks achieved by the CPU 20 include a TCP/IP module 10, a distribution control module 50, a print job receiving module 60, an SNMP manager 40, and an SNMP agent 70.

The TCP/IP module 10 interprets the TCP/IP protocol and, primarily, performs communications with the outside via the network. TCP (Transmission Control Protocol) and UDP (User Datagram Protocol) are protocols that perform transport-layer processes in the TCP/IP protocol. TCP is a protocol that achieves high-reliability connection-type communications. On the other hand, UDP is a protocol that achieves high speed connectionless communications. The TCP/IP module 10 not only performs the print job communications using TCP, but also performs communications between the SNMP manager 40 and the SNMP agent 70 using the UDP.

The distribution control module 50 receives a print job designated for distributed printing (hereinafter termed a “distributed print job”) and distributes the print job to the distribution destinations. The distribution control module 50 is provided with a distribution destination select module 52, a receiving status determining module 54, and a print job sending module 56, as sub-function blocks. The distribution destination select module 52 selects at least one distribution destination printer from among the printers connected to the custom network board 100 to be the distribution destination for the print job. The receiving status determining module 54 determines whether or not the distribution destination printer is in a state wherein it is possible to receive the print job immediately. The receiving status determining module 54 includes a command sending module 541 for sending commands used in determining whether or not a printer is in a state capable of receiving a print job immediately, and a response receiving module 542 for receiving the responses to the commands that are sent. The print job sending module 56 sends the print job to a distribution destination printer that has been determined to be able to receive the print job immediately. The processes performed by the distribution control module 50, as described above, will be explained in greater detail.

The print job receiving module 60 receives a normal print job, for which distributed printing has not been specified (hereinafter termed a “normal print job”) and provides the print job to the printer controller 80. The print job receiving module 60 was provided with a response module 61 for receiving a response to a command included in a print job from the printer controller 80 and sending a response to the sender of the print job.

The SNMP manager 40 uses a communications protocol known as SNMP (Simple Network Management control Protocol) to query the SNMP agents 70 that are equipped in each of the printers PRT1 through PRT4 to receive a variety of information. The SNMP manager 40 designates the OID, described above, to specify information to be received in order to execute the query.

The SNMP agent 70 acquires specific information from the aforementioned MIB file in response to the query by the SNMP manager 40, and sends that information to the SNMP manager 40.

On the other hand, memory 30, in addition to storing programs for executing the various functions described above, has an OID storage area 32, a distribution destination designator file storage area 34, and a buffer 36. The OID storage area 32 stores the OID that is designated when the SNMP manager 40 performs a query as described above. The OID is stored in association with the type of information that can be queried, and the SNMP manager 40 is able to acquire the OID by referencing the OID storage area 32. The distribution destination designation file storage area 34 stores the distribution destination designation file. This distribution destination designation file is used when one wishes to limit those printers can be used as the distribution destination in distributed printing among the plurality of printers connected to the LAN, by specifying printers in advance. Consequently, when it is not necessary to make a designation in this way, nothing is stored in the distribution destination designation file storage area 34. The buffer 36 is a storage area for storing temporarily received print job data.

The printer PRT2, as shown in FIG. 2, is provided with a printer body PRB2 and the network board 200 described above. The structure of the printer body PRB2 has the same structure as the printer body PRB1 for the printer PRT1, described above, so the same codes are assigned as for the structural elements of the printer body PRB1 of the printer PRT1, and explanations thereof are omitted. The network board 200 has the same functions as those in the custom network board, 100, described above, with the exception of the exclusion of the distributed printing control functions. In other words, the network board 200 has a TCP/IP module 10, a print job receiving module 60, and an SNMP agent 70. The various constituent elements of the network board 200 have the same functions and same structures as the constituent elements with the same names in the custom network board 100, and explanations thereof are omitted.

As can be understood from the explanation above, the custom network boards 100 installed in the printers PRT1 and PRT4 are provided with all of the functions provided in the network boards 200 that are installed in the printers PRT2 and PRT3. In other words, when viewed from the distribution control module 50 of the custom network board 100, the printers PRT1 through PRT4 are completely identical, and all can be designated as distribution destination printers in the distributed printing process described below. The distribution control module 50 can treat the printer PRT1 that houses the distribution control module 50 itself as being no different than any of the other printers.

The client CLa, as shown in FIG. 2, has, in addition to an application 11, a TCP/IP module 13 and a print job sending module 12 as functional blocks. The client CLa interprets the TCP/IP protocol to communicate with the outside through the network. The TCP/IP module 13 has the same functions and structures as the TCP/IP module 10 of the custom network board 100, described above. The print job sending module 12 generates print jobs in response to print requests from the application 11, and sends the generated print job through the TCP/IP module 13 to a printer PRT. Note that a distributed printing job for which distributed printing is designated can be sent only to the printers PRT1 and PRT4 that are provided with the custom network boards 100, where normal print jobs for which distributed printing is not specified can be sent to any of the printers PRT1 through PRT4.

The printer PRT4 has the same structure as the printer PRT1, described above, and the printer PRT3 has the same structure as the printer PRT2, described above. The client CLb has the same structure as the client CLa, described above. Detailed descriptions of these are omitted.

Receiving a Normal Print Job by a Printer

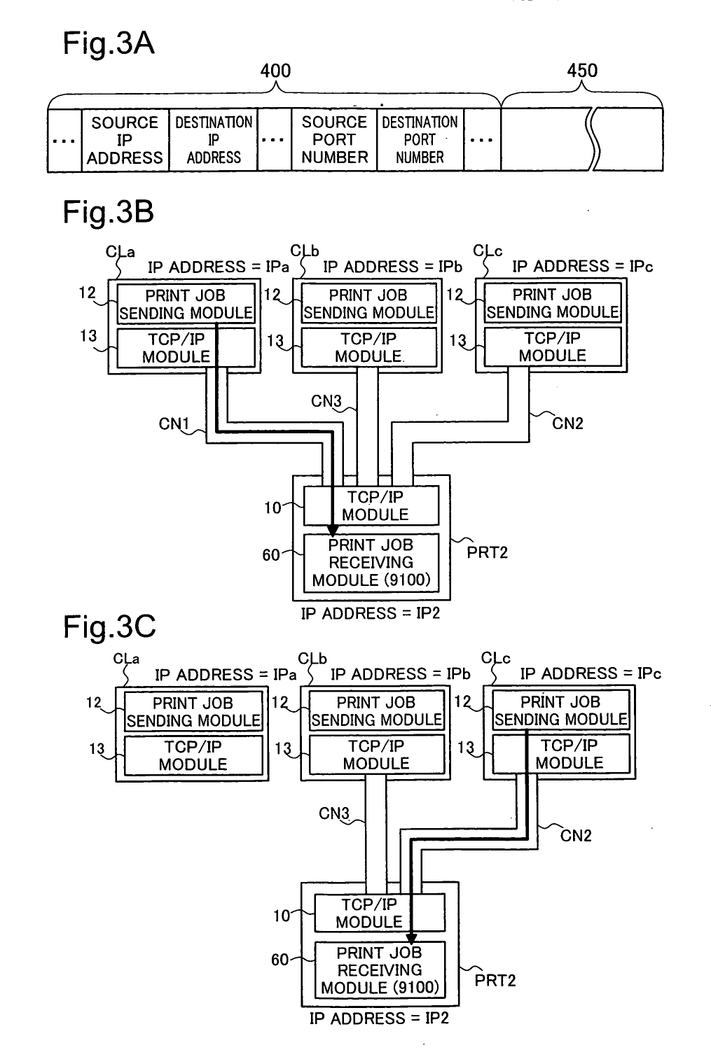

Before describing the distributed printing process, the reception of a normal print job by a printer PRT will be described in reference to FIGS. 3A-C. FIGS. 3A-C show schematics for explaining the reception of normal print jobs. FIG. 3A schematically illustrates the structure 6f the communication data used in print job communication. FIGS. 3B-C schematically describe the reception of a print job when a plurality of connections is maintained.

The print job is sent as communication data formatted according to the TCP/IP protocol. The communication data, as shown in FIG. 3A includes a header 400 and a data part 450. Of these, the header 400 not only includes the IP address of the device that is the source from which the communication data is sent (the source IP address) and a port number that specifies the software that is the source within the device (the source port number), but also includes the IP address of the device that is the destination to which the communication data is sent (the destination IP address) and a port number that specifies the software that is the destination within the device (the destination port number). The communication data sent from the software in the device that is the transmission source is sent to the device that has that IP address, according to the destination IP address, and within the device that has received the communication data, the communication data is passed to the software that owns the destination port number. The data part 450 stores the data to be communicated. In this embodiment, The data part 450 stores the print job data 500 described below.

For example, when a normal print job is sent from the client CLa to the printer PRT2, the header 400 of the communication data has “IP2” as the destination IP address, and “9100” as the destination port number. The “9100” is a port number possessed by the print job receiving module 60 that will receive the normal print job. Moreover, the header 400 has “IPa” as the source IP address and the port number that is possessed by the print job sending module 12 as the source port number.

Further description will be presented sequentially. When the client CL application 11 issues a print instruction, the print job sending module 12 of the client CL sends the print job data through the TCP/IP module 13 according to the print protocol. In this embodiment, a non-procedural protocol is used as the print protocol. The TCP/IP module 13 of the client CL establish a connection with the TCP/IP module 10 of the printer PRT that is the transmission destination. The establishment of the connection is done according to the TCP, which is a connection-type communications protocol, prior to sending the print job data.

Establishment of the connection means forming a virtual communications path for communicating data between the two processes (which, in this embodiment, are the print job sending module 12 and the print job receiving module 60). In the below, this virtual communications path is termed a “connection.” Using the connection makes it possible to perform high reliability bi-directional streaming transfers. In other words, sending the print job though the connection makes it possible to prevent data from becoming out of sequence in the transmission, and possible to prevent the loss of data.

FIG. 3B illustrates schematically that the three clients CLa through CLc all attempt to send print jobs in parallel to a single printer PRT2. Codes CN1 through CN3 indicate connections that are established between the TCP/IP modules 13 of the clients CLa through CLc and the TCP/IP module 10 of the printer PRT2, where the numbers at the ends of the codes indicate the sequence in time in which the connections were made. In other words, the TCP/IP module 13 of the client CLa was first, the TCP/IP module 13 of the client CLc was second, and the TCP/IP module 13 of the client CLb was third in each establishing connections with the TCP/IP module 10 of the PRT2.

In this way, the TCP/IP module 10 is configured so as to be able to establish and maintain multiple connections simultaneously. In this embodiment a maximum of 8 connections can be established. This is because if it were not possible to establish more than one connection, then when multiple clients would attempt to send print jobs in parallel to the same printer PRT, it would not be possible for the client CL to recognize the printer PRT when attempting to establish a second connection, or beyond, to the printer PRT. If the client CL were unable to recognize the printer PRT there would be the danger of problems such as the client CL determining that the power is not turned onto the printer PRT, determining that the physical connection with the printer PRT was broken, or the like.

On the other hand, the print job receiving module 60 of a printer PRT is structured so as to receive one print job at a time from one connection. The printer controller 80 is unable to process multiple print jobs in parallel, so the print job receiving module 60 will have to provide the print job data, one at a time, to the printing controller 80. As described above, the print job receiving module 60 receives print jobs with the priority on the print jobs that are sent through the connection established first. In the specific example shown in FIG. 3B, the print job receiving module 60 of the printer PRT2 receives first the print job sent from the client CLa through the connection CN1, which was established first. The print job receiving module 60 provides the print job that has been received to the printer body PRB2 according to the printing protocol. While the print job receiving module 60 is receiving a print job sent from the client CLa, the other clients CLb and CLc maintain their connections CN3 and CN2, and are caused to wait. Explaining in greater detail, in communications using the TCP protocol, when the data flow is controlled (using control where the data flow is enabled/disabled) so when the print job receiving module 60 that is the higher-level application for the TCP/IP module 10 does not receive the print job through the connection (that is, does not receive the print job from the TCP/IP module 10), the flow of data is prohibited by the flow control for the TCP/IP module 10. In other words, the transmission source TCP/IP module (which, in this case, is the TCP/IP module 13 in the client CLb and the client CLc) is instructed to not send data. In this state, the clients CLb and CLc are unable to send data, and so are in a waiting state until data transmission is enabled. In the below, this state will be referred to as a “waiting state.”

When the entire print job sent from the client CLa has been received by the print job receiving module 60, the TCP/IP module 10 terminates the connection CN1. After the connection CN1 has been terminated, then, as shown in FIG. 3C, the print job receiving module 60 receives a print job from the client CLc through connection CN2, which was the second connection to be established. When the print job receiving module 60 is ready to receive the print job that is sent through the connection CN2, the TCP/IP module 10 allows the data flow through the flow control described above. That is, the TCP/IP module 10 permits the transmission source TCP/IP module 10 to send data. In this way, the waiting state of the client CLc is released so that the print job can be sent.

In this way, the print job receiving module 60 receives print jobs sequentially in the order in which the connections were established, and by providing, to the printing controller 80 of the printer body PRB2, the print jobs that have been received, the printing is performed sequentially in the order of client access.

As can be understood from the explanation above, in this embodiment, the TCP/IP module 10 that establishes the connection for the print job receiving module 60 to receive the print job is equivalent to the first communication module in the claim 1.

Distributed Printing Processing:

The distributed printing process in the first embodiment will be explained in detail next. When performing distributed printing, the user confirms that in the printer driver at the client (for example, the client CLa (FIG. 1)) has the print protocol set to a no-procedure protocol, the setting of the port number is changed from the normal “9100” to the special “59100” or “59101.” In other words, in this embodiment, the port number setting is changed to select normal printing with the normal “9100” or distributed printing with the specific “59100” or “59101.” Furthermore, in this embodiment it is possible to select two different modes for distributed printing. One is a “divided mode”, and the other is a “copy mode”. These two modes can be selected by setting the port number. The user sets the port number to “59100” when selecting the divided mode, and sets the port number to “50101” when selecting the copy mode.

The divided mode is a distributed printing mode wherein a specified number of print copies is assigned to a distribution destination printer. For example, in the divided mode, if a distributed print job for 100 copies is received then by sending normal print jobs for 25 copies to each of the printers PRT1 to PRT4 to perform the printing will result in printing a total of 100 copies. In the divided mode, the emphasis is on printing the specified number of copies quickly.

The copy mode is a distributed printing mode wherein specified numbers of copies are printed at each of the distribution destination printers. For example, in the copy mode, if a distributed print job for one copy is received, a total of four copies is printed by sending a normal printing job for one copy to each of the printers PRT1 through PRT4. The copy mode emphasizes printing with high reliability on a large number of distributed printers, more than emphasizing the speed of printing.

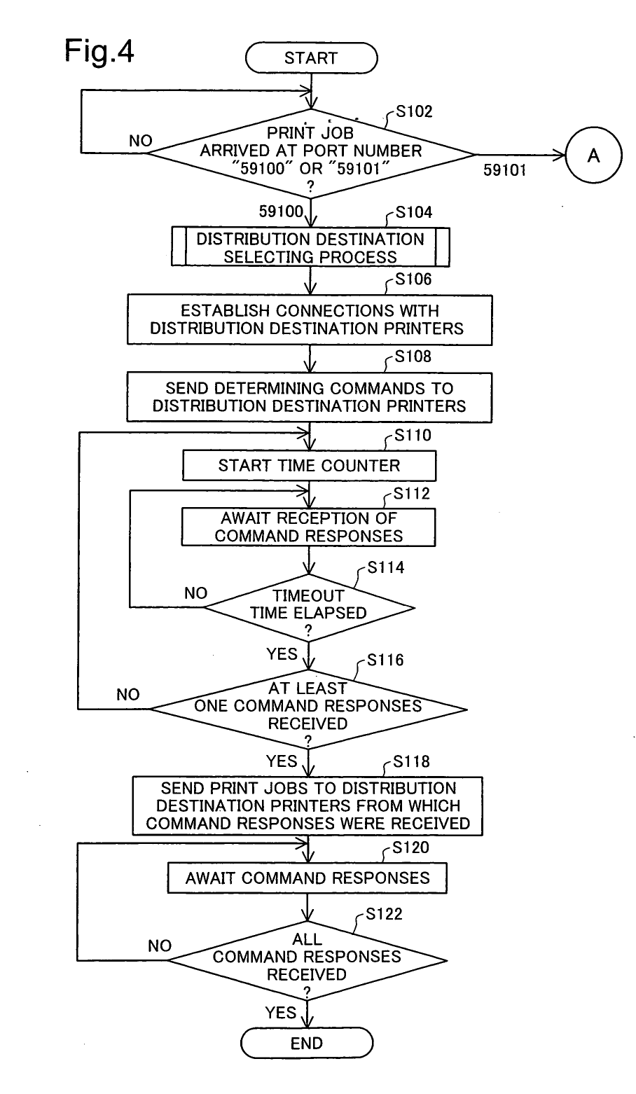

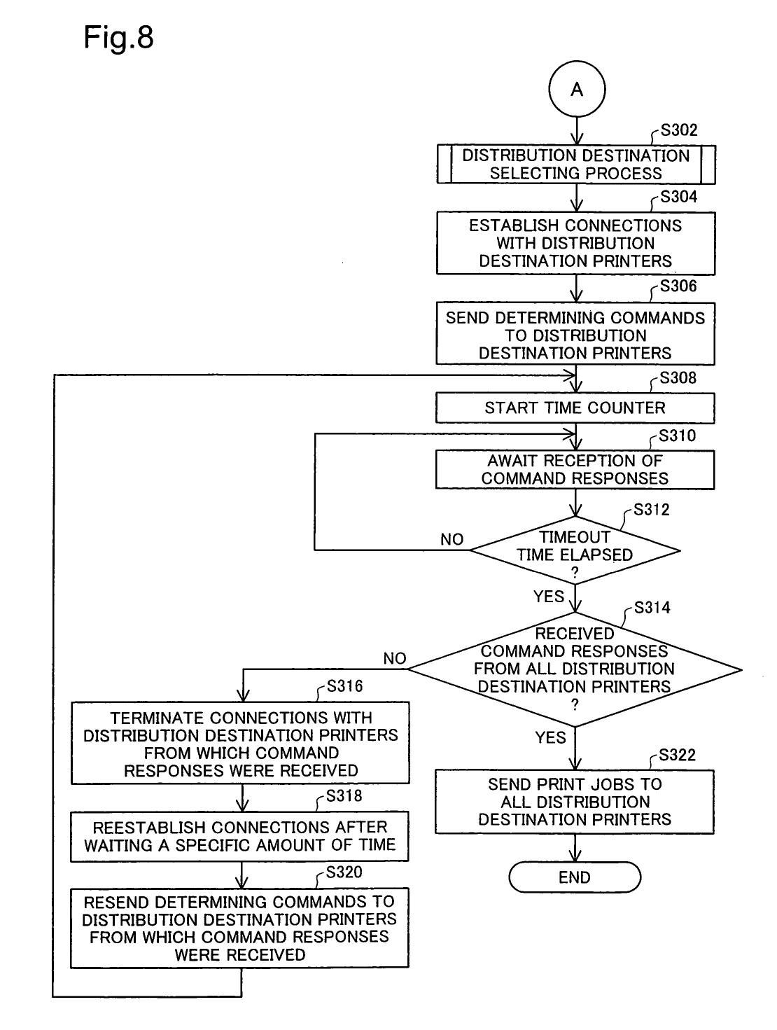

FIG. 4 shows a first flow chart illustrating a processing routine for a distributed printing process in a first embodiment. The distributed printing process in the first embodiment is a process that is executed by a distribution control module 50 that is equipped with a CPU 20 of a custom network board 100. When a printer wherein a custom network board 100 is installed (for example, printer PRT1) is in a state that is able to receive a print job, the distribution control module 50 constantly monitors whether or not a print job has arrived at port number “59100” or “59101” (Step S102). For example, when communication data including a print job arrives from the client CLa at the printer PRT1, the destination port number included in the communication data is acquired by the TCP/IP module 10. If the port number is “59100” or “59101,” then the TCP/IP module 10 reads out the print job from the communication data and sequentially passes the print job to the distribution control module 50. If the print job is received from the TCP/IP module 10 as data for which the destination port number is “59100,” then the distribution control module 50 jumps to the process that executes the divided mode (starting at step S104). If the print job is received from the TCP/IP module 10 as data for which the destination port number is “59101,” then the distribution control module 50 jumps to the process that executes the copy mode (FIG. 8). Note that the distribution control module 50 stores temporarily the received print job in a buffer 36.

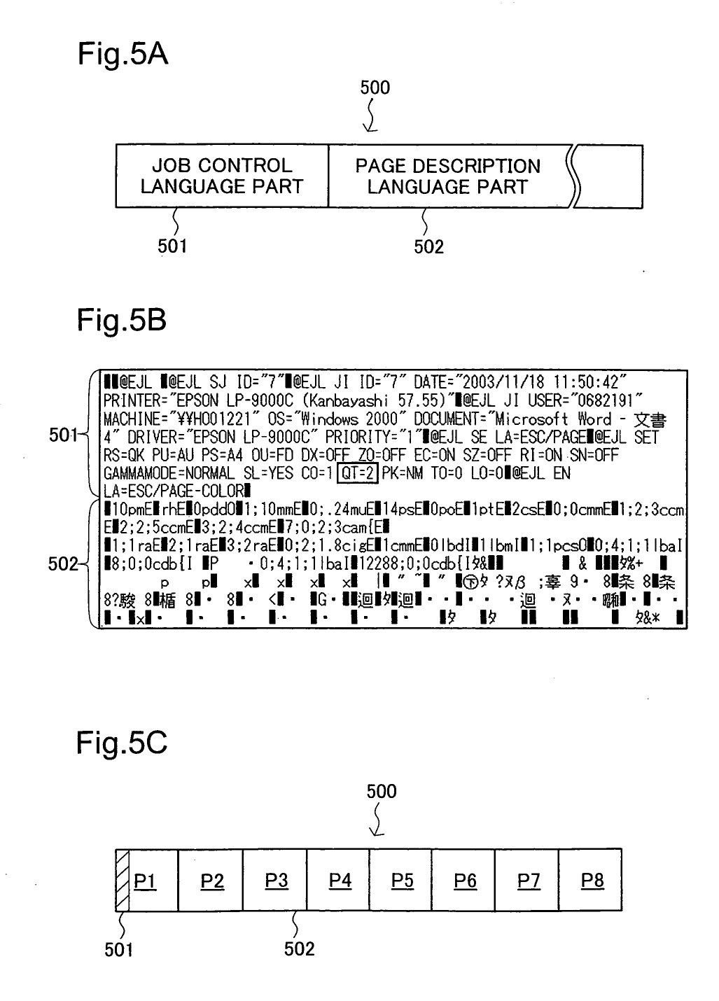

Here the print job is structured as data having a specific format (hereinafter termed the “print job data”). FIGS. 5A-C show schematics for explaining the print job data. FIG. 5A illustrates the print job data schematically. FIG. 5A is an explanatory diagram illustrating one example of print job data opened in an editor. FIG. 5C is a diagram illustrating schematically the state wherein print job data is divided into packets. The print job data 500, as shown in FIG. 5A-B, has a job control language part 501 and a page description language part 502. The page description language part 502 is a part wherein the details of the print is described using a specific page description language. For the page description language, ESC/Page or Postscript, or the like may be used. The job control language part 501 describes the attributes required for printing the print details that is described in the page description language part 502, including the number of copies to print, the paper size, and the type of page description language that is used in the descriptions in the page descriptor language part 501. The job control language part 501 is written using a specific job control language, and uses EJL (Epson Job Language) in this embodiment.

When it comes to the size of the print job data, while the size increases depending on the amount of printing in each copy, the size of the buffer 36 is limited, so in practice the print job data 500 is divided into groups of data (hereinafter termed “packets”) that are smaller than the capacity of the buffer 36 when they are received from the client. In FIG. 3C the print job data 500 is divided into the packets P1 through P8. At the point in time wherein the print job arrives, at the aforementioned step 102, only packet P1 is received, and stored in the buffer 36.

The explanation continues, returning to FIG. 4. For convenience in the explanation, first the process that is performed in the divided mode will be explained, and the process that is performed in the copy mode is explained later. When the process that performs the divided mode is started, the distribution destination select module 52 of the distribution control module 50 executes the destination printer selecting process (Step S104).

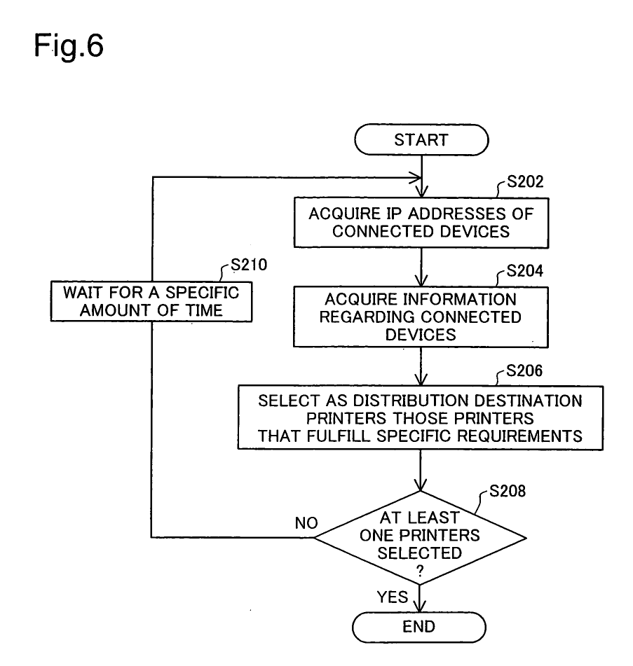

FIG. 6 shows a flowchart illustrating a processing routine in a distribution destination selecting process. When the distribution destination selecting process is started, the distribution destination select module 52 acquires the IP addresses of the devices that are connected to the network (Step S202). If a distribution destination designation file is stored in the distribution destination designation file storage area 34, the distribution destination select module 52 references the distribution destination designation file to acquire the IP addresses. The distribution destination designation file contains a list of IP addresses, of printers that can be used as the distribution destinations. This type of distribution destination designation file can be stored in the distribution destination designation file storage area 34 when, for example, a service technician performs the initial setup of the printer PRT1 or connects a computer for setting up the printer PRT1. Note that the installation may also be performed over the LAN. Note that when this type of distribution destination designation file is used, then if one wished to use the local printer PRT1 as one of the distribution destinations, then the IP address “IP1” of the local printer PRT1 must also be listed in the distribution destination designation file.

On the other hand, if there is no distribution destination designation file stored, then the distribution destination select module 52 uses the SNMP manager to query the IP addresses of each of the devices connected to the LAN by broadcasting to the LAN, to acquire the respondent IP addresses.

Following this, the distribution destination select module 52 acquires information pertaining to each of the devices to which the acquired IP addresses are allocated (Step S204). Specifically, the distribution destination select module 52 uses the SNMP manager to query each of the devices using a multicast to acquire the equipment name and status as the query response.

The distribution destination select module 52 searches for printers, from among all of the devices connected to the network, that fulfills specific conditions, based on the acquired equipment names and statuses, and selects as distribution destination printers the printers that are retrieved (Step S206). In the divided mode, these specific conditions are as follows:
1. that the machine type be the same as the local printer PRT1;
2. that the power supply be turned on;
3. that the remaining toner is above a specific threshold;
4. that the printer be on-line; and
5. that the printer is not busy (that the printer engine 90 is not currently being driven).

The information regarding these conditions can all be acquired through queries through the SNMP manager. The machine type being the same as the local printer PRT1 being a condition for selecting the equipment as a distribution destination printer is to make it possible to print correctly without modifying the print job data for each of the distribution destination printers. The result is that it is possible to insure uniformity in the quality of the printed material at each of the distribution destination printers, such as uniformity in resolution, font, and the like. The color printing and double-sided printing designation will also be identical. The querying of the equipment names to the printer wherein the IP addresses are specified in the distribution destination designation file is for the following reason: After the distribution destination designation file has been generated, the IP addresses listed in the distribution destination designation file may be assigned to a printer of a different machine type than the local printer PRT1, or may be assigned to a non-printer device, due to replacement of equipment after the distribution destination designation file is made, and thus this is to confirm that the machine type is identical to the local printer PRT1.

The second through fifth conditions are to prevent the selection of a printer that will not be available to print immediately, as the distribution destination printer. The on-line status indicates a normal state wherein there is no error such as being out of paper, having a paper jam, or the like.

After this, the distribution destination select module 52 determines whether or not at least one distribution destination printer has been selected (Step S208). If at least one printer has been selected (Step S208: Yes), then the distribution destination select module 52 has completed the distribution destination selecting process. If no distribution destination printers have been selected (Step S208: No), then the distribution destination select module 52 waits a specific amount of time (Step S210), and then repeats the processes in Steps S202 through S208. In this embodiment, some or all of the printers PRT1 through PRT4, as distribution destinations printers are selected as distribution destination printers.

When the distribution destination printers have been selected, the distribution control module 50 establishes connections with each of the selected distribution destination printers in order to send the print job from the distribution control module 50 to the print job receiving module 60 in each of the distribution destination printers (Step S106). Specifically, the distribution control module 50 performs a connection establishment process between the TCP/IP module 10 of the custom network board 100, and the TCP/IP module 10 of the distribution destination printers. The connection is established when a TCP packet (the SYN packet) is sent from the custom network board 100 to the distribution destination printer indicating a first establishment request, a TCP packet (the ACK/SYN packet) that serves as both a receipt acknowledgement to the first establishment request and as a second establishment request from the distribution destination printer to the custom network board 100 is sent, and a TCP packet (the ACK packet) indicating a receipt response to the second establishment request is sent between the two TCP/IP modules 10. As can be understood by the explanation above, in this embodiment, the TCP/IP module 10 with which the distribution control module 50 establishes a connection for sending the print job is equivalent to the second communication module in the claim 1.

The command sending module 541 of the receiving status determining module 54 sends a determining command through each of the connections that has been established to each of the distribution destination printers (Step S108). In this embodiment, a EJLID command is used as the determining command. The EJLID command is written in EJL, which is the job control language described above. The EJLID command requests the print job receiving module 60 of the distribution destination printer to immediately respond with the device ID. The device ID is information for specifying the manufacturer and model of the printer, where the EJLID command is normally used by the device that is the source of the print job in selecting the type of printer driver.

The EJLID command, written in the job control language, is received by the print job receiving module 60 in the same manner as is the print job. Consequently, the receiving of the EJLID command by the print job receiving module 60 and the return of the response by the print job receiving module 60 indicates that the print job receiving module 60 is in a state wherein a print job can be received immediately (hereinafter termed the “immediate receiving-capable state”). In other words, the connection that is used in sending the EJLID command is the connection that was established first, from among the connections currently maintained to the distribution destination printers, and this indicates that print job sender will not be the aforementioned waiting states when an attempt is made to send a print job from this connection. On the other hand, if the print job receiving module 60 does not receive an EJLID command that has been sent, and does not return a response, this indicates that the print job receiving module 60 is not in an immediate receiving-capable state. In other words, a connection that has been established prior to the connection that is used for sending the EJLID command is currently maintained with the destination distribution printer. Thus when an attempt is made to send a print job from a connection that has been used in sending the EJLID command, the print job sender will be in the waiting state described above.

When the determining command is sent, the receiving status determining module 54 begins a time count for counting the time out time (Step S110), and awaits the reception of a response to the determining command that has been sent (hereinafter termed the “command response”) (Step S112). When a command response come from the print job receiving module 60 of the distribution destination printer during this time period, then the response receiving module 542 of the receiving status determining module 54 receives the command response.

The receiving status determining module 54 confirms whether or not the specific timeout time has elapsed (Step S114), and if the time out time has not elapsed (Step S114: No), then the aforementioned command response reception wait is continued. If the timeout time has elapsed (Step 114: Yes), then the response receiving module 542 determines whether or not one or more command responses has been received (Step S116). If the receiving status determining module 54 determines that the response receiving module 542 has not yet received a command response (Step S116: No), then the receiving status determining module 54 returns to Step S110, and again awaits the reception of a command response.

When the receiving status determining module 54 determine that the response receiving module 542 has received at least one command response (Step S116: Yes), then the print job sending module 56 of the distribution control module 50 sends a print job to the print job receiving module 60 of the distribution destination printer from which the command response was sent (Step S118). This is because, as described above, the print job receiving module 60 of the distribution destination printer from which the response was returned can be determined to be in an immediate receiving-capable state. Specifically, the print job sending module 56 can use, as is, the connection from which the command response was sent, to send a print job to the print job receiving module 60 that is in a waiting state at the distribution destination printer on the other end of the connection. If command responses are received from more than one distribution destination printer, then print jobs are sent to all distribution destination printers that sent command responses. On the other hand, the print job is not sent to any distribution destination printer that have not sent command responses before the timeout time has elapsed. This is because those print job receiving modules 60 for distribution destination printers that have not sent command responses immediately can be judged to be other than the immediate receiving-capable state.

Here the print job to be sent to the distribution destination printer is addressed to the print job receiving module 60 (port 9100), and so can be said to be a “normal” print job. If there is more than one possible distribution destination printer to which the normal print job should be sent, then the number of print copies notated in the distributed print job is distributed, as uniformly as possible, to normal print jobs to be sent to the two or more distribution destination printers. Specifically, in FIG. 5B, the value written as “QT” in the job control language part 501 indicates the number of copies to print, and by changing this value it is possible to set the number of copies to be printed, which are distributed to normal print jobs. Note that the process for sending print jobs to multiple distribution destination printers in this step will be described later.

When the sending of the print job has been completed, then the connection with the distribution destination printer to which the print job has been sent is finished. The connection is finished through mutually executing, between the two TCP/IP modules 10 of the custom network board 100 and the distribution destination printer, of the request/response process comprising a TCP packet indicating a finish request (the FIN packet) and a TCP packet indicating the acknowledgement of the receipt of the finish request (the ACK packet).

The command sending module 541 sends a determining command in Step S108, but when there is still a distribution destination printer that cannot yet send a command response, then the distribution control module 50 waits for the command response to be sent (Step S120), and once all of the command responses have been sent back (Step S122: Yes), then the process is completed. The processes in Steps S120 and S122 are processes that are required for the software specifications, which require that the response be received, and are not processes that are essentially necessary in the distributed printing process.

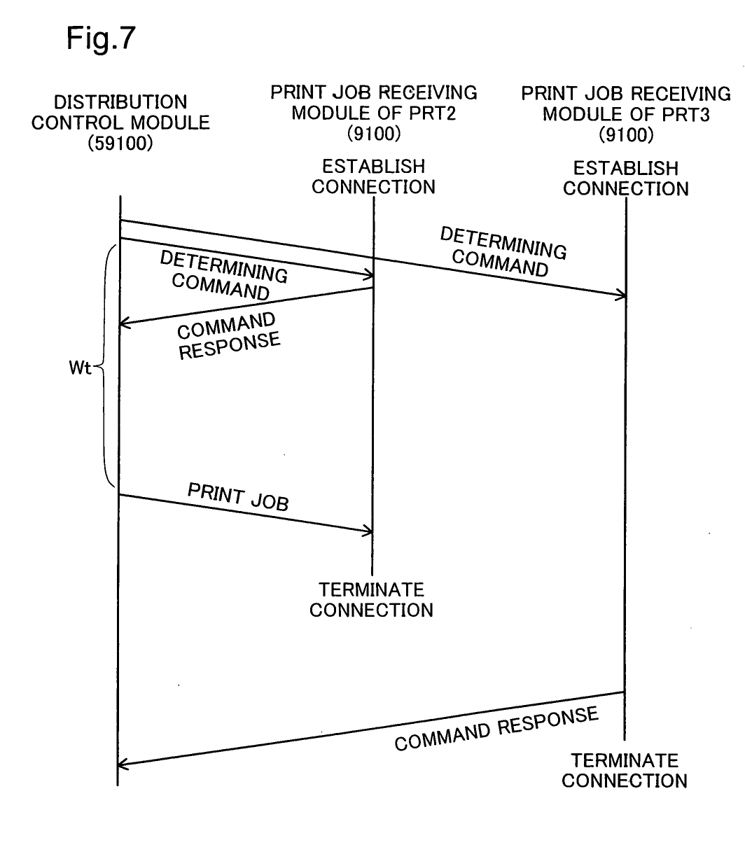

Following this, FIG. 7 will be referenced in explaining the communications sequence between the distribution control module 50 of the custom network board 100 and the print job receiving module of the distribution destination printer in the aforementioned divided mode. FIG. 7 shows one example of a communications sequence in the divided mode according to the first embodiment. FIG. 7 illustrates a case wherein printer PRT2 and printer PRT3 are printers to which connections have been established as distribution destination printers in the aforementioned Step 106.

When a connection is established (FIG. 4: Step S106), a determining command is sent from the distribution control module 50 to the print job receiving modules 60 of each of the printers PRT2 and PRT3. In the example in FIG. 7, the print job receiving module 60 of the printer PRT2 is in the immediate receiving-capable state, or in other words, has returned the command response immediately. On the other hand, the print job receiving module 60 of the printer PRT3 is not in the immediate receiving-capable state, and has not immediately returned the command response. A specific wait time Wt after the determining command is sent (corresponding to the time between the beginning of the time count and the timeout time), the print job is sent from the distribution control module 50 to the print job receiving module 60 of the printer PRT2, which has, by that time, returned the command response. When the transmission of the print job has been completed, the connection between the distribution control module 50 and the print job receiving module 60 of the printer PRT2 is terminated. Following this, the print job receiving module 60 of the printer PRT3 enters the state that is capable of reception, and receives the determining command, so the command response is returned to the distribution control module 50 from the print job receiving module 60 of the printer PRT3. After this, the connection between the distribution control module 50 and the print job receiving module 60 of the printer PRT3 is terminated without the print job being sent to the print job receiving module 60 of the printer PRT3 from the distribution control module 50.

Next the process that executes the copy mode will be explained referencing FIG. 8. FIG. 8 shows a second flowchart illustrating a processing routine in a distributed printing process according to the first embodiment. When the process that execute the copy mode is started, a distribution destination select module 52 of the distribution control module 50 executes the distribution destination selecting process (Step S302). The distribution destination selecting process in the copy mode, while somewhat different from the distribution destination selecting process in the divided mode (FIG. 4: Step S104), has the same basic steps, and, as with the divided mode, will be explained using FIG. 6.

When the distribution destination selecting process is started, the distribution destination select module 52 obtains the IP addresses of the devices that are connected to the network, in the same manner as in the divided mode (Step S202). Next the distribution destination select module 52 obtains information regarding each of the devices to which the obtained IP addresses are allocated (Step S204). Unlike in the divided mode, the information received here in the copy mode is only the machine name.

The distribution destination select module 52 uses the information that has been received to search among the devices connected to the network for printers that fulfill specific conditions, and selects as distribution destination printers those printers that are found (Step S206). The specific conditions in the copy mode are only the following two, unlike the case of the divided mode:
1. the machine type is the same as for the local printer PRT1; and
2. the power supply is turned on.
   In Step S204, the power supply is on if the machine neme is obtained using SNMP, and so fundamentally only a single condition must be confirmed.

Having fewer conditions for selecting the distribution destination printers than in the divided mode is because the copy mode as described above, places the emphasis on printing to a large number of distribution destination printers.

The distribution destination select module 52 causes one or more distribution destination printers to be selected reliably using the same process as in the divided mode. (See Steps S208 and S210.)

The explanation will continue, returning to FIG. 8. When the distribution destination printers have been selected, the distribution control module 50 establishes connections with each of the selected distribution destination printers, in the same manner as in the case of the divided mode, in order to send print jobs to the print job receiving modules 60 of each of the distribution destination printers from the distribution control module 50 (Step S304). However, in the copy mode, attempts are made repetitively to establish the connections until connections have been established to all of the selected distribution destination printers. This is also because the emphasis in the copy mode is on printing to a large number of distribution destination printers.

The command sending module 541 of the receiving status determining module 54 sends a determining command to each of the distribution destination printers through the respective connections that have been established, in the same manner as for the divided mode (Step S306). When a determining command has been sent, the receiving status determining module 54 starts a time count (Step S308) and awaits a command response (Step S310) in the same manner as for the divided mode.

The receiving status determining module 54 checks whether or not a specific timeout time has elapsed (Step S312), and if the timeout time has not elapsed (Step S312: No), then the receiving status determining module 54 continues to wait for the command response, as described above. When the timeout time elapses (Step S312: Yes), the response receiving module 542 determines whether or not a command response has been received from all of the distribution destination printers (Step S314). If the receiving status determining module 54 determines that there is a distribution destination printer from which a command response has not yet been received (Step S314: No), then the distribution control module 50 terminates the connections with the distribution destination printers from which the command responses have been received (Step S316). The distribution control module 50, after waiting a specific amount of time, again establishes connections with each of the distribution destination printers for which the connections had been terminated in Step S316 (Step S318). In Step S318, random numbers are used so that the wait time will not always be the same amount of time. The reason for performing Steps S316 and S318 is to use a random number so that the wait time in this step will not always be the same. The reasons for performing Steps S316 and S318 are described below.

When the connections have been reconfirmed, the distribution control module 50 again sends a determining command (Step S320) to each of the distribution destination printers from which a command response has been received in the immediately proceeding command response reception wait interval (Step S310). When the determining commands have been resent, the distribution control module 50 returns to Step S308, and again awaits commands over a specific time period (Steps S308 through S312).

If during the specific time period, the receiving status determining module 54 determines that a command response has been received from each of the selected distribution destination printers (Step S314: Yes), the print job sending module 56 sends print jobs to the print job receiving module 60 in each of the selected distribution destination printers (Step S322). The condition that a command response is received from each of the distribution destination printers even in this step (indicating that each of the distribution destination printers is in the immediate receiving-capable state) is because printing to a large number of distribution destination printers is emphasized in the copy mode, as described above. Just as in the divided mode, the print job sending module 56 uses the connections, as they are, through which the command responses were sent, to thus send the print job to the print job receiving modules 60 of the distribution destination printers that are on the other end of these connections.

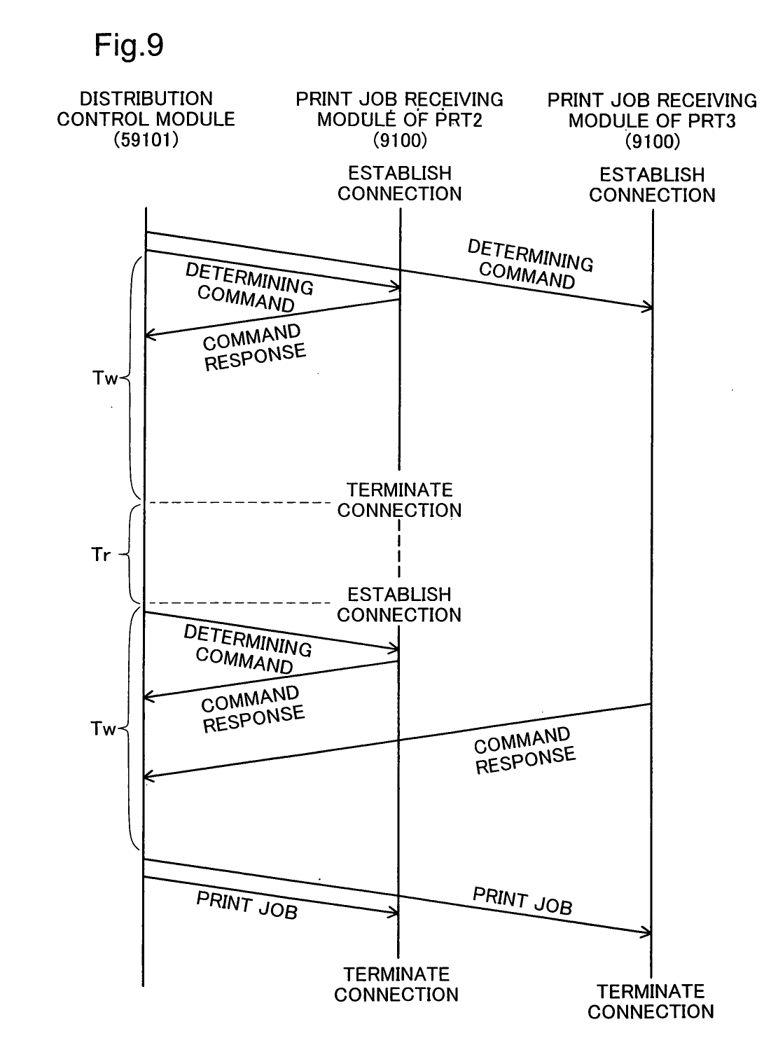

Next, FIG. 9 will be used to explain the communications sequence between the distribution control module 50 of the custom network board 100 and the print job receiving module 60 of the distribution destination printer in the aforementioned copy mode. FIG. 9 shows one example of a communications sequence in the copy mode according to the first embodiment. In FIG. 9, the printers wherein connections have been established in the Step S304, as the distribution destination printers, are, as an example, the printer PRT2 and the printer PRT3.

When the connections are established (FIG. 8: Step S304), the determining command is sent to the respective print job receiving modules 60 of each of the printers PRT2 and PRT3, from the distribution control module 50. In the example in FIG. 9, the print job receiving module 60 of the printer PRT2 is in the immediate receiving-capable state, and immediately returns the command response, the print job receiving module 60 of the printer PRT3 is not in the immediate receiving-capable state, and the command response is not returned immediately. Because the command response is not returned from the printer PRT3 during the specific wait time Wt after the transmission of the determining command, the connection between the distribution control module 50 and the print job receiving module 60 of the printer PRT2, from which the command response was sent, is terminated for the time being. After this, after a specific wait time Wr has elapsed, the connection between the distribution control module 50 and the print job receiving module 60 of the printer PRT2 is reestablished. A determining command is resent, through the connection that has been established, from the distribution control module 50 to the print job receiving module 60 of the printer PRT2.

After the determining command has been resent, the command responses are received from both the printer PRT2 and the printer PRT3 within the second wait period Wt. In other words, the print job receiving module 60 of the printer PRT2 is in the immediate receiving-capable state at the point in time of the second determining command transmission as well, and the command response is returned immediately from the print job receiving module 60 of the printer PRT2 to the distribution control module 50. On the other hand, the print job receiving module 60 of the printer PRT3 transitioned into the immediate receiving-capable state during the second wait period Wt, and received its first determining command, and returned the command response to the distribution control module 50 from the print job receiving module 60 of the printer PRT3 during the second wait period Wt. The result is that at the end of the second wait period Wt it is determined that both the printer PRT2 and the printer PRT1 are in the immediate receiving-capable state, and the respective print jobs are sent to the respective print job receiving modules 60 of the printer PRT2 and the printer PRT3 from the distribution control module 50.

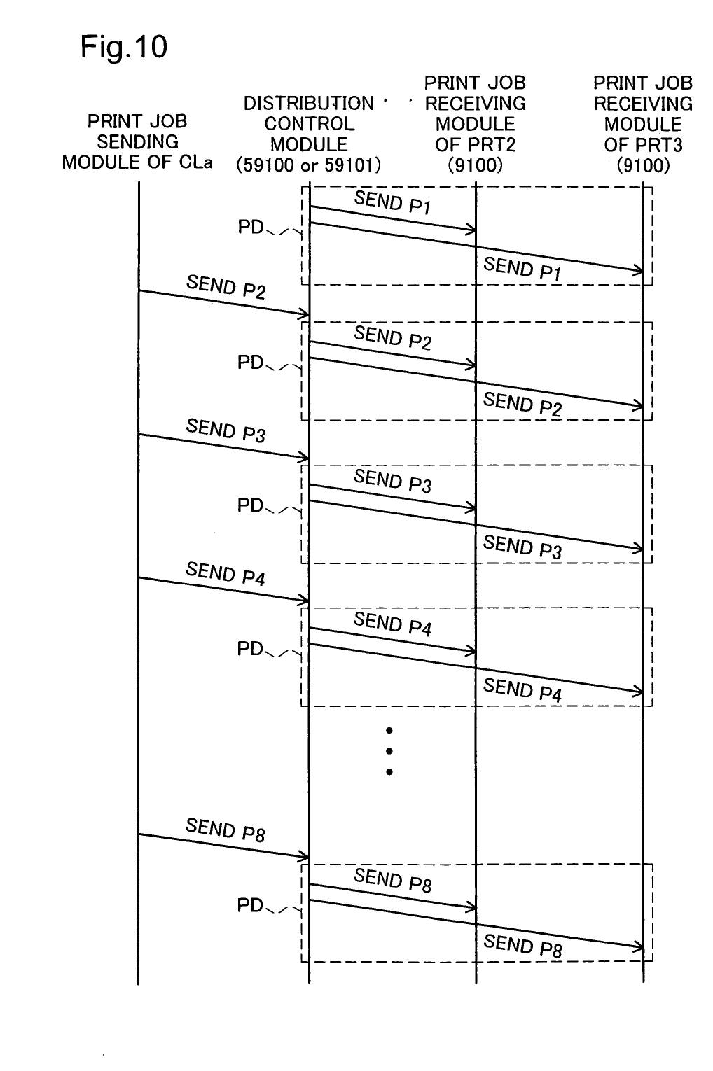

Next the transmission of the print job from the distribution control module 50 to the print job receiving module 60 of the distribution destination printers in the distribution control process will be explained further referencing FIG. 10. FIG. 10 shows a one example of a communications sequence wherein a print job is sent to a plurality of print job receiving modules 60. FIG. 10 shows the situation where a print job sent from a client CLa is received by the distribution control module 50 of the printer PRT1, and the received print job is sent (distributed) to the print job receiving modules 60 of the two printers PRT2 and PRT3.

As was described above, referencing FIG. 5C, the print job data 500 is divided into packets that are smaller than the buffer 36 and received from the client. Consequently, while in FIG. 7 and FIG. 9, the transmission of the print job is shown simply by a single arrow, actually the transmission of the print job from the distribution control module 50 to the print job receiving modules 60 of the distribution destination printers must be performed by being divided into multiple transmission by the packet unit. The example shown in FIG. 10 illustrates the case wherein the print job data 500 is sent divided into eight packets P1 to P8, shown in FIG. 5C.

When the distribution control module 50 begins the transmission of the print job (FIG. 4: Step S118, or FIG. 8: Step S322), first the packet P1, which is initially stored in the buffer 36 (the first packet in the print job, which includes the job control language part 501) is sent to the print job receiving modules 60 of the respective printers PRT2 and PRT3. In the below, the transmission of a packet in this way to the print job receiving modules 60 of each of a plurality of distribution destination printers will be referred to as “packet distribution.” In FIG. 10, the group of arrows surrounded by the dotted lines, shown by the symbol PD correspond to the packet distribution.

When the completion of the packet distribution PD of the first packet P1 has been confirmed, the distribution control module 50 receives the second packet from the client CLa, as shown in FIG. 10. The confirmation of the completion of the packet distribution PD is performed by the TCP/IP modules 10 of the transmission source and the transmission destination. The distribution control module 50 erases the packet P1 stored in the buffer 36 and stores into the buffer 36 the packet P2 that has just been received. The distribution control module 50 performs the packet distribution PD of the packet P2 stored in a buffer 36, in the same manner as for the packet P1. The same process is executed repetitively for the remaining packets P3 through P8 that structure the print job data 500 to ultimately send the print job data 500 to the print job receiving modules 60 of all of the printers PRT2 and PRT3.

According to the custom network board 100 as a printing control device pertaining to this embodiment, when a print job is sent through a connection, the print job is sent after determining that the print job receiving module 60 of the distribution destination printers are in a state capable of receiving the transmitted print job immediately, making it possible to achieve smooth distributed printing. That is to say, when the custom network board 100 sends print jobs to the distribution destination printers, there is no obstruction to the progress of the distributed printing due to the aforementioned waiting state.

Furthermore, the custom network board 100 in this embodiment can prevent the occurrence of deadlock. Here “deadlock” refers to the problem of the distributed printing process coming to a complete stop. For example, it is assumed that a printing system that includes at least two custom network boards 100 and at least two distribution destination printers that can be specified as the distribution destinations for print jobs for the respective at least two custom network boards 100. Conventionally, in this system, deadlock may occur when at least two custom network boards 100 attempt to send print jobs to the at least two distribution destination printers as essentially the same time in a distributed printing process.

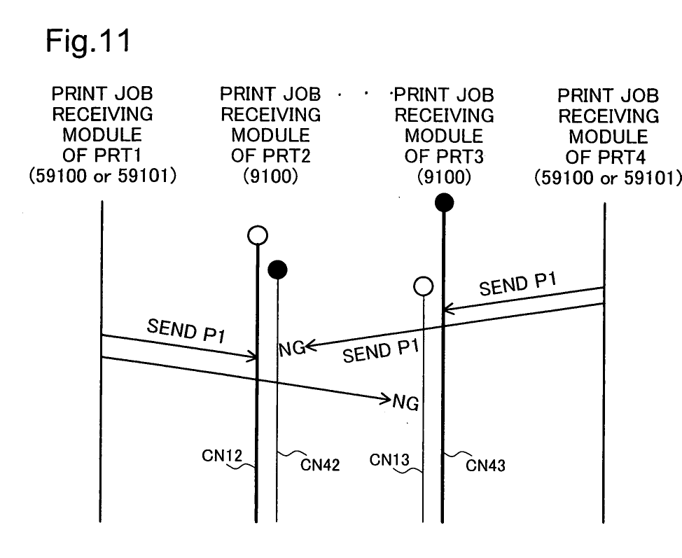

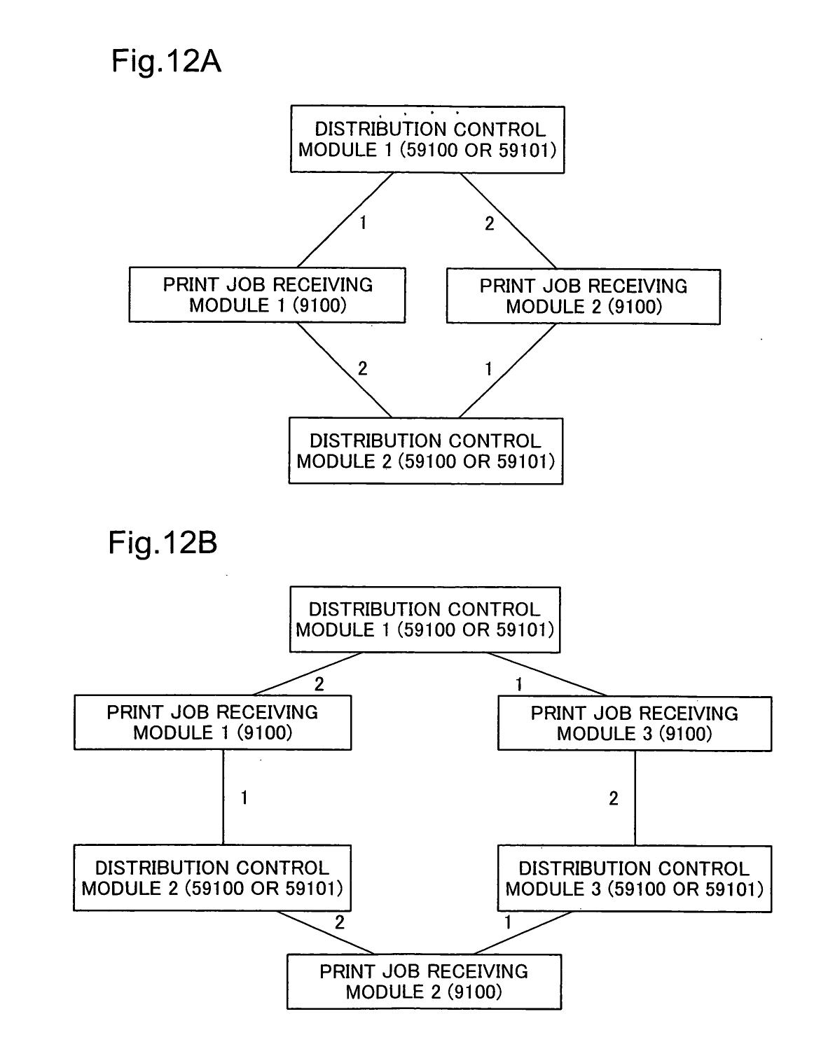

Here, for ease of understanding, FIG. 11 and FIG. 12 will be referenced in explaining the mechanism by which deadlock occurs. FIG. 11 shows a communications sequence when deadlock occurs. FIGS. 12A-B show diagrams illustrating schematically a case wherein deadlock occurs. Solid lines in FIG. 12 show connections. FIG. 11 and FIG. 12 show the case wherein deadlock occurs when a distributed printing process is performed without using the determining commands to confirm whether or not the printers are in the immediate receiving-capable state, or in other words, without performing Steps S106 through S116 in FIG. 4 or Steps S306 through S320 in FIG. 8.

For example, the various connections are established when attempting to send print jobs, essentially simultaneously, to the print job receiving modules 60 of the printer PRT2 and the printer PRT3 from the distribution control module 50 of the printer PRT1 and the distribution control module 50 of the printer PRT2. As described above, the TCP/IP modules 10 for each of the printers are able to maintain a plurality of connections simultaneously, and thus succeed in establishing each of the connections. In FIG. 11, the white-filled circles show the timing with which the connections are established between the distribution control module 50 of the printer PRT1 and each of the print job receiving modules 60 of the printers PRT2 and PRT3. On the other hand, the black-filled circles show the timing with which connections are established between the distribution control module 50 of the printer PRT4 and each of the print job receiving modules 60 of the PRT2 and the printer PRT3.

As is shown in FIG. 11, the connection with the print job receiving module 60 of the printer PRT2 is established first by the distribution control module 50 of the printer PRT1. Following this, the print job receiving module 60 of the printer PRT2 receives, with priority the print job sent from the distribution control module 50 of the printer PRT1, and until the completion of the reception of this entire print job, the distribution control module 50 of the printer PRT4 will be in a waiting state.

On the other hand, as is shown in FIG. 11, the connection of the print job receiving module 60 of the printer PRT3 is established first by the distribution control module 50 of the printer PRT4. Consequently, the print job receiving module 60 of the printer PRT3 receives with priority the print job that is sent by the distribution control module 50 of the printer PRT4, and until the reception of the entire print job has been completed, the distribution control module 50 of the printer PRT1 will be in a waiting state. In FIG. 11, the heavy solid lines show the connections CN12 and CN43 that receive print jobs with priority, where the light solid lines indicate the connections C42 and C13 that are in the waiting state.

In such a state, the distribution control module 50 of the PRT1 attempts to perform the aforementioned packet distribution PD (FIG. 10) through the connections C12 and C13 that have been established, to thereby send the print job to the respective print job receiving modules 60 of the printers PRT2 and PRT3. In this case, the packet P1 that is sent to the print job receiving module 60 of the printer PRT2 is received immediately, but the packet P1 that is sent to the print job receiving module 60 of the printer PRT3 cannot be received because the priority level of the connection CN13 is low. Because of this, the distribution control module 50 of the printer PRT1 will enter a waiting state, being unable to complete the first packet distribution PD.

Similarly, the distribution control module 50 of the printer PRT4 attempts to send a print job to the print job receiving modules of the printers PRT2 and PRT3 through the connections C42 and C43 that have been established. In this case, the packet P1 that is sent to the print job receiving module 60 of the printer PRT3 is received immediately, while the packet P1 that is sent to the print job receiving module 60 of the printer PRT2 is not received because of the low priority position of the connection CN42. Because of this, the distribution control module 50 of the printer PRT 4 cannot complete the first packet distribution PD, and goes into a waiting state, in the same manner as the distribution control module 50 of the printer PRT1.

The result is that the distributed printing processes of the distribution control module 50 of the printer PRT1 and of the distribution control module 50 of the printer PRT4 both fall into a completely stopped state. The waiting state of the distribution control module 50 of the printer PRT1 is not released until the distributed printing process by the distribution control module 50 of the printer PRT4 is completed, while, on the other hand, the waiting state of the distribution control module 50 of the printer PRT4 is not released until the distributed printing process by the distribution control module 50 of the printer PRT1 has been completed.

The deadlock as in FIG. 11 occurs in a case such as shown in FIG. 12. When described schematically, deadlocks can occur in a system that has a plurality of distribution control modules, which are the side that sends the print jobs, and plurality of print job receiving modules, which are the side that receives the print jobs, where a ring is formed through the alternating of distribution control modules and print job receiving modules through connections for communication between distribution control modules and print job receiving modules. Executing the distributed printing process in a state wherein a connection ring, such as described above, is established and at least one connections in each of the print job receiving modules in the ring are in a waiting state will result in a deadlock state. When it comes to the numbers associated with the connections in FIGS. 12A-B, 1 indicates a connection that is in a immediate receiving-capable state, and 2 indicates a connection that is in a waiting state.

The custom network board 100 according to this embodiment performs confirmations of the immediate receiving-capable state using the determining command, and so no print job is sent to a distribution destination printer that is in a waiting state. This can prevent reliably the deadlock as described above. For example, even if in the divided mode connections were established with the timing shown in FIG. 11, the distribution control module 50 of the printer PRT1 sends the print job to the print job receiving module 60 of the printer PRT2 only when it is determined, by the determining command, that the state is an immediate receiving-capable state, thus avoiding the deadlock that is described above.

In the copy mode, the reason for temporarily terminating the connections (FIG. 8: Step S316) and determining, using random numbers, the time for waiting before reestablishing the connections (FIG. 8: Step S318) is to avoid this type of deadlock. For example, in the copy mode, connections are established by the distribution control modules 50 of the printer PRT1 and the printer PRT2 with the timing shown in FIG. 11. In this case, unless at least one of the connections that are in the immediate receiving-capable state, for the distribution control modules 50 of the printer PRT1 and the printer PRT4 is temporarily terminated, then it is impossible for one distribution control module 50 to occupy the connections that are in the immediate receiving-capable state. Because of this, in copy mode, the connections in the immediate receiving-capable state are temporarily terminated in Step S316 of FIG. 8. Following this, after the connections are temporarily terminated, if both the distribution control modules 50 for the printer PRT1 and the printer PRT4 were to establish connections with the same timing again after the same wait time, then again each of the distribution control modules 50 would compete to establish the connections, and it would be difficult for either of the distribution control modules 50 to occupy the connections in the immediate receiving-capable state. Because of this, in Step S316 of FIG. 8, the wait times before reestablishing the connections are established using random numbers. This quickly avoids the deadlock even copy mode, making it possible for the distributed printing process to advance smoothly.

Furthermore, for the determining command, the EJL ID command, which is written in EJL is used, where EJL is a language wherein at least a part of the print job is written. Consequently, if the printer has the ability of interpret the EJL function, then the printer will be able to return a response to the ELJ ID command. The result is that a printer that is able to interpret the existing EJL command can be used as the distribution destination printer as is.

Furthermore, because the connection over which the command response is sent is used as is to send the print job, this is able to determine reliably the print job receiving module 60 that is on the other end of the connection is in an immediate receiving-capable state. For example, if the check were performed using a communications protocol of a connectionless type, such as SNMP, as a higher level above the UDP layer, then the would be possible for a connection to be established to another device in the instant after the confirmation when the connection is to be established, but in this embodiment, there is no such problem.

Furthermore, the print job is divided into a plurality of packets, and is sent using the packet distribution described above (FIG. 10), thus making it possible to reduce the capacity required in the buffer 36 in the custom network board 100. The result is a reduction in the number of parts and a reduction in the manufacturing cost of the custom network board 100, along with a reduction in size thereof. Furthermore, it is possible to distribute print jobs in parallel to a plurality of distribution destination printers even when the capacity of the buffer in the distribution destination printer (for example, the printer buffer 82 of the printer PRT2) is small. 107 Furthermore, because the distribution control module 50 is housed within a printer (PRT1 or PRT4), no dedicated server is used, making it possible to achieve a small distributed printing system easily.

Furthermore, the distribution control module 50 is capable of designating, as the distribution destination, the local printer that houses the custom network board 100 that contains the distribution control module 50, increasing the range of selections for the distribution destination printers.

### B. Second embodiment

Structure of a Distributed Printing System

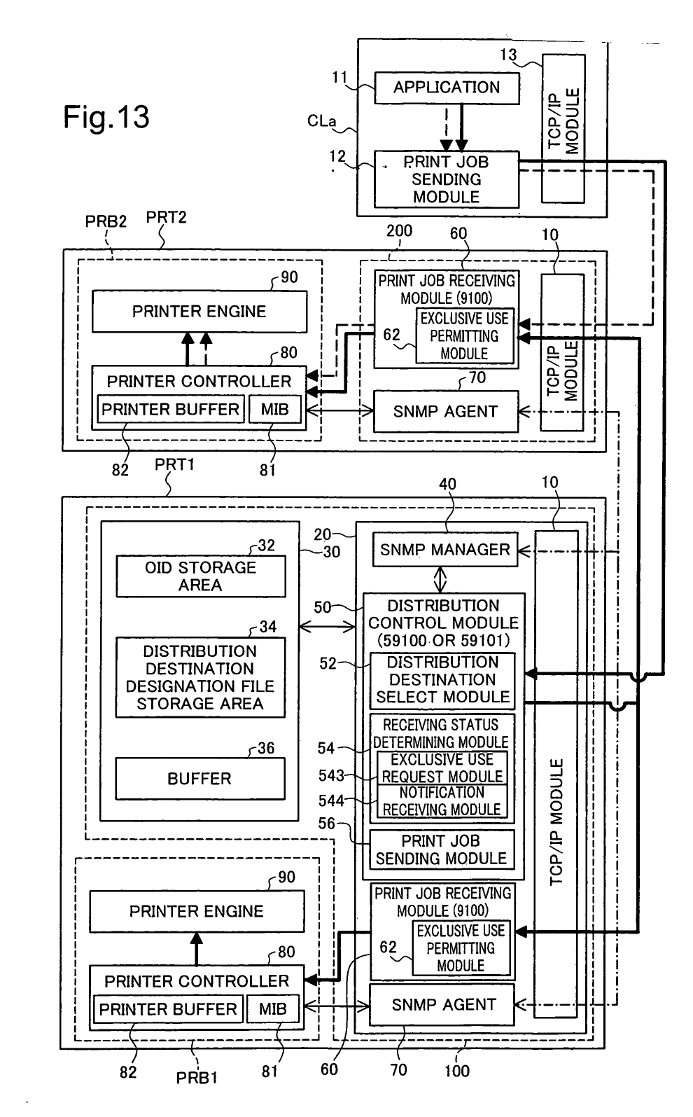

A configuration of a distributed printing system according to a second embodiment is the same as the configuration in the first embodiment, which was described in reference to FIG. 1, and thus the explanation thereof will be omitted. FIG. 13 shows a block diagram of the internal structures of each device in a distributed printing system according to a second embodiment.

When compared to the printer PRT1 in the first embodiment, the printer PRT1 in the second embodiment differs in that the configuration of the distribution control module 50 and the print job receiving module 60 within the custom network board 100. The distribution control module 50 in the second embodiment has an exclusive use request module 543 instead of the command sending module 541 in the first embodiment, and a notification receiving module 544 instead of the response receiving module 542. The exclusive use request module 543 send commands relating to exclusive use requests that request the exclusive use of the distribution destination printers. The notification receiving module 544 receives notification regarding the commands sent by the exclusive use request module.

Moreover, the print job receiving module 60 in the second embodiment is provided with an exclusive use permitting module 62 instead of the response module 61 in the first embodiment. The exclusive use permitting module 62 is a functional block for allowing the exclusive use of the printer PRT1 to the sending device that attempts to send a print job to the printer PRT1.

The other structures of the printer PRT1 in the second embodiment are the same as those of the printer PRT1 in the first embodiment shown in FIG. 2, and thus identical codes are applied in FIG. 13 to the structural elements that are identical to those in FIG. 2, and explanations thereof are omitted.

When compared to the printer PRT2 in the first embodiment, the printer PRT2 in the second embodiment differs in the configuration of the print job receiving module 60 within the network board 200. That is, the print job receiving module 60 in the second embodiment is provided with the aforementioned exclusive use permitting module 62 instead of the response module 61 in the first embodiment, similar to the case for the print job receiving module 60 in the aforementioned printer PRT1. The other structures in the printer PRT2 in the second embodiment are identical to those in the printer PRT2 in the first embodiment, shown in FIG. 2, and thus identical codes are applied in FIG. 13 to the structural elements that are identical to those in FIG. 2, and explanations thereof are omitted. Note that, as in the first embodiment, a printer PRT4 is provided with the same configuration as the printer PRT1, and a printer PRT3 is provided with the same configuration as the printer PRT2 in the second embodiment as well, and explanations thereof are omitted.

Process of the Exclusive use permitting module in the Distribution Destination Printers:

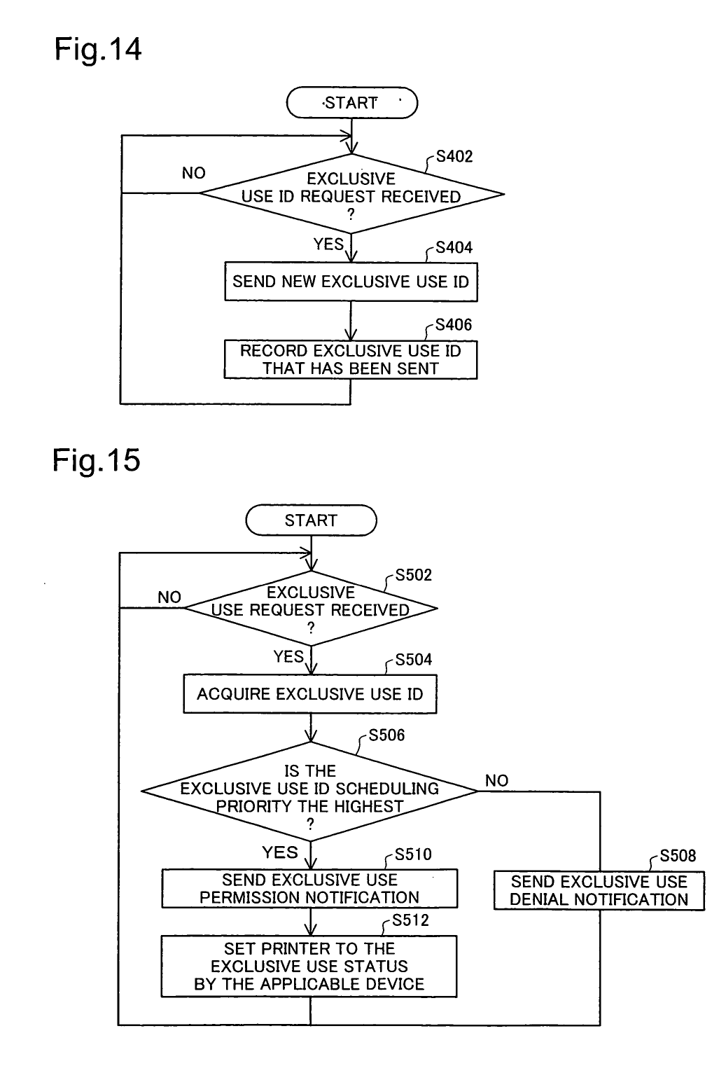

Further explanation is provided below regarding the processes performed in the exclusive use permitting module 62 included in the print job receiving module 60 of the printers PRT that serve as distribution destination printers in this embodiment. First an explanation will be given regarding the exclusive use scheduling process performed by the exclusive use permitting module 62, referencing FIG. 14. FIG. 14 shows a flowchart illustrating a processing routine for an exclusive use scheduling process. The exclusive use permitting module 62 always performs this exclusive use scheduling process when the power supply is turned ON. When the exclusive use scheduling process is performed, the exclusive use permitting module 62 constantly monitors whether or not an exclusive use ID request has been received (Step S402). The exclusive use ID request is one of the commands relating to exclusive use requests, and is a command that schedules the exclusive use of a printer PRT. A device that attempts to send a print job to a printer PRT (hereinafter termed the “sending device”) sends an exclusive use ID request to the printer PRT prior to sending an exclusive use request, described below. The sending device may be a computer or a server connected to the LAN, including the distribution control module 50 of the custom network board 100 in this embodiment.

When an exclusive use ID request is received (Step S402: Yes), the exclusive use permitting module 62 sends, to the sending device from which the exclusive use ID request was received, a response that provides an exclusive use ID. In the below, the sending of this response shall be termed “issuing an exclusive use ID.” The exclusive use ID is used by the exclusive use permitting module 62 in controlling the sequence in which exclusive use is permitted to the sending devices, and is a fixed ID that is different for each exclusive use ID request.

The exclusive use permitting module 62 records the exclusive use ID that is issued to the sending device (Step S406). At this time, the exclusive use ID is recorded in such a way that the sequence in which the exclusive use IDs are issued can be understood, or the exclusive use ID itself is the serial number with which the exclusive use ID is issued. In the below, being earlier in the sequence in which the exclusive use ID is issued shall be termed as having a higher scheduling priority, and being later in the sequence in which exclusive use IDs are issued shall be termed as having a lower scheduling priority. When the exclusive use permitting module 62 stores the exclusive use ID, processing returns to Step S402, returning to a state wherein the exclusive use permitting module 62 awaits the reception of an exclusive use ID request.

Next the exclusive use permitting process performed by the exclusive use permitting module 62 will be explained in reference to FIG. 15. FIG. 15 shows a flowchart illustrating a processing routine for an exclusive use control process. The exclusive use control process is always performed in parallel with the aforementioned exclusive use scheduling process, by the exclusive use permitting module 62 when at least one exclusive use IDs are issued. When the exclusive use scheduling process is performed, the exclusive use permitting module 62 always monitors whether or not an exclusive use request is received (Step S502). The exclusive use request is one of the aforementioned commands relating to exclusive use requests, a command whereby the exclusive use of a printer PRT is requested. When attempting to send a print job, the sending device sends, to the printer PRT that issued the exclusive use ID, an exclusive use request that includes an exclusive use ID that has already been received. On the printer PRT side, the exclusive use permitting module 62 receives the exclusive use request that is sent from the sending device.

When the exclusive use request is received (Step S502: Yes), the exclusive use permitting module 62 obtains the exclusive use ID that is included in the exclusive use request that has been received (Step S504). The exclusive use permitting module 62 references the exclusive use ID that has been issued and recorded, and determines whether or not the scheduling priority of the exclusive use ID included in the exclusive use request is the highest scheduling priority (Step S506). If it is determined that the scheduling priority of the exclusive use ID that is included in the exclusive use request is not the highest scheduling priority (S506: No), then the exclusive use permitting module 62 decides not to permit exclusive use of the printer PRT to the sending device from which the exclusive use request has been sent, and instead sends, as a response to the exclusive use request, an exclusive use denial notification (Step S508).

On the other hand, when it is determined that the scheduling priority of the exclusive use ID that is included in the exclusive use request is of the highest scheduling priority (Step 506: Yes), then the exclusive use permitting module 62 decides to permit the exclusive use of the printer PRT to the sending device that sent the exclusive use request, and sends, as a response to the exclusive use request, an exclusive use permission notification (Step S510). The exclusive use permitting module 62 places the printer PRT into a state wherein the printer PRT is used exclusively by the sending device to which the permission notification is sent (Step S512). For example, the TCP/IP module 10 is informed of the IP address of the sending device to which exclusive use is permitted, and an instruction is given to the TCP/IP module 10 to establish a connection with only the device having the aforementioned IP address.

The result is that the print job receiving module 60 will always go into the aforementioned immediate receiving-capable state when the sending device to which exclusive use has been permitted has established a connection for sending the print job to the print job receiving module 60. That is, the sending device to which exclusive use has been permitted will not be in a waiting state after the connection is established, but rather the print job receiving module 60 will be able to receive immediately the print job that is sent. In other words, if the sending device receives permission for exclusive use of the printer PRT from the exclusive use permitting module 62 prior to the establishment of the connection, then it can be determined that the print job receiving module 60 will be in the immediate receiving-capable state when the connection with the print job receiving module 60 of the printer PRT is established thereafter.

When Step S512 or Step S508 is completed, then the exclusive use permitting module 62 returns to Step S502, returning to the state wherein the exclusive use permitting module 62 monitors the reception of an exclusive use request.

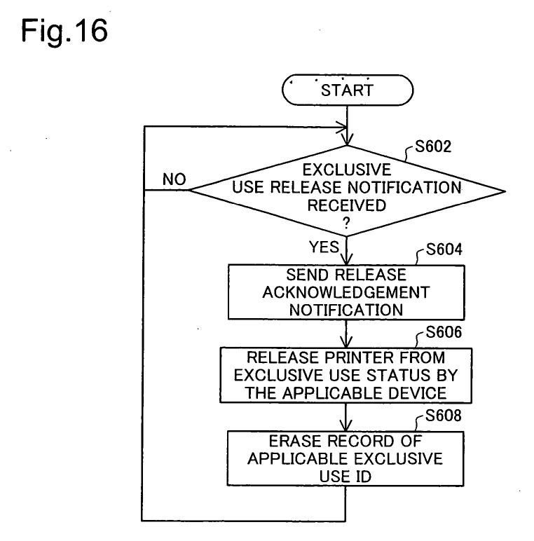

The exclusive use release process, performed by the exclusive use permitting module 62, will be explained next, in reference to FIG. 16. FIG. 16 shows a flowchart illustrating a processing routine for an exclusive use releasing process. The exclusive use releasing process is performed in parallel with the aforementioned exclusive use scheduling process and exclusive use permitting process by the exclusive use permitting module 62 when exclusive use of the printer PRT is permitted to a sending device. When exclusive use is permitted to a sending device, the exclusive use permitting module 62 monitors whether or not an exclusive use release notification has been received (Step S602). The exclusive use release notification is a command that provides notification of the release of exclusive use by the sending device that currently has exclusive use of the printer PRT. When the sending device that has been permitted exclusive use has finished sending, to the printer PRT, a print job to be printed, then the exclusive use release notification is sent to the printer PRT.

When the exclusive use release notification is received, the exclusive use permitting module 62 replies, as a response to the exclusive use release notification, with a release acknowledgement notification acknowledging the release of the exclusive use (Step S604). The exclusive use permitting module 62 releases the printer PRT from the state wherein the printer PRT is used exclusively by the sending device from which the exclusive use release notification has been sent (Step 606). For example, an instruction is issued to the TCP/IP module 10 to not establish any connection with a sending device. The exclusive use permitting module 62 deletes the record of the exclusive use ID contained in the exclusive use request to which exclusive use is permitted, or in other words, the exclusive use ID with the highest scheduling priority (Step S608). The result is that the exclusive use ID that had the second highest scheduling priority is recorded as the exclusive use ID with the highest scheduling priority. When the steps described above have been completed, the exclusive use permitting module 62 returns to Step 602.

In the processing by the exclusive use permitting module 62, described above, the exchange of the various types of commands with the sending device is all performed using SNMP as an upper layer of UDP, which is a connectionless-type communications protocol. In other words, the sending device is provided with an SNMP manager (for example, the SNMP manager 40 in the case wherein a custom network board 100 is the sending device), and the exclusive use ID request, exclusive use request, and exclusive use release notification are sent through the SNMP manager. The exclusive use permitting module 62 responds to these commands through an SNMP agent 70 to send the exclusive use ID, the permission notification, the denial notification, and the release acknowledgement notification. Consequently, the exchange of these commands/responses do not require a connection, and can be executed independently regardless of whether or not there is a connection for sending the print job.

The Distributed Printing Process:

The distributed printing process according to a second embodiment will be explained assuming the use of printers PRT that are equipped with the exclusive use permitting module 62, that performs the processes described above, as the distribution destination printers.

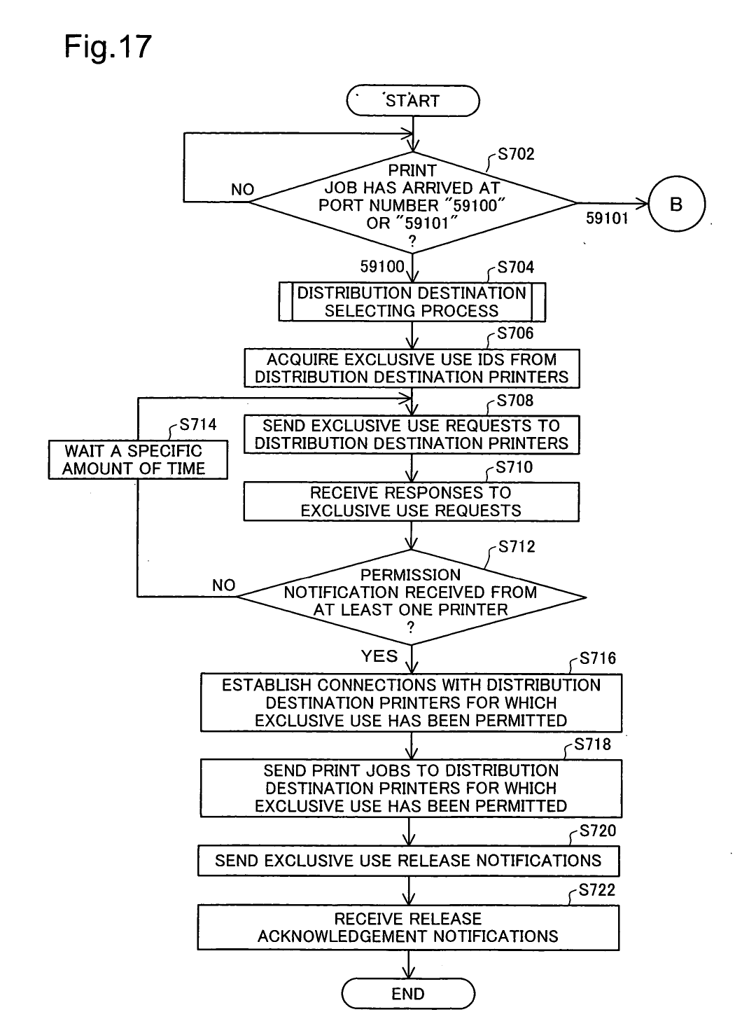

FIG. 17 shows a first flowchart illustrating a distributed printing processing routine according to the second embodiment. In the distributed printing process according to the second embodiment, Step S702 is identical to Step S102 in the first embodiment, and is a process wherein the decision is made whether to shift into the divided mode process or to shift into the copy mode process depending on the part number at which the print job is received. As with the first embodiment, the process in the divided mode (beginning in Step 704) will be explained first. Step S704 is identical to Step S104 in the first embodiment, and is a process that selects the distribution destination printers. When the distribution destination printers have been selected, the receiving status determining module 54 of the distribution control module 50 acquires an exclusive use ID from each of the selected distribution destination printers (Step 706). Specifically, the exclusive use request module 543 of the receiving status determining module 54 sends the aforementioned exclusive use ID requests through the SNMP manager 40 to each of the distribution destination printers. The result is that the notification receiving module 544 of the receiving status determining module 54 can acquire exclusive use IDs from the exclusive use permitting modules 62 of each of the distribution destination printers in response to the exclusive use ID requests.

When the exclusive use IDs have been acquired, the exclusive use request module 543 of the receiving status determining module 54 records the exclusive use IDs that have been received, and sends exclusive use requests to each of the distribution destination printers that issued exclusive use IDs (Step S708). The result is that the notification receiving module 544 of the receiving status determining module 54 receives a permission notification or denial notification, described above, from the exclusive use permitting module 62 of each of the distribution destination printers in response to the exclusive use requests (Step S710).

The receiving status determining module 54 is able to determine, for a distribution destination printer that has sent a permission notification, that the print job receiving module 60 will be in an immediate receiving-capable state when a connection is established thereafter with the print job receiving module 60 of the distribution destination printer.

In the receiving status determining module 54, the notification receiving module 544 determines whether or not one or more permission notifications have been received (Step S712). In other words, this is the same as determining whether or not there are one or more distribution destination printers wherein the print job receiving module 60 is in an immediate receiving-capable state. The receiving status determining module 54 returns to Step S708 after a specific amount of wait time has elapsed (Step S714) when the received notifications are all denial notifications (Step S712: No). On the other hand, the distribution control module 50 established a connection (Step S716), for sending the print job, with the distribution destination printers that have sent a permission notification in the case wherein the receiving status determining module 54 has received at least one permission notifications (Step S712: Yes). The print job sending module 56 of the distribution control module 50 sends the print job (Step S718) to the distribution destination printer that have sent the permission notifications, through the connections that have been established. The sending of the print jobs is performed through repeating the packet distribution PD in the same manner as in the first embodiment.

When the print job sending is completed, the exclusive use request module 543 sends the release notification, described above, to the distribution destination printers that had send the exclusive use permission notifications (Step S720). When the notification receiving module 544 receives the aforementioned release acknowledgement notification, as a response to the release notification that has been sent (Step S722), the processing in the divided mode is completed.

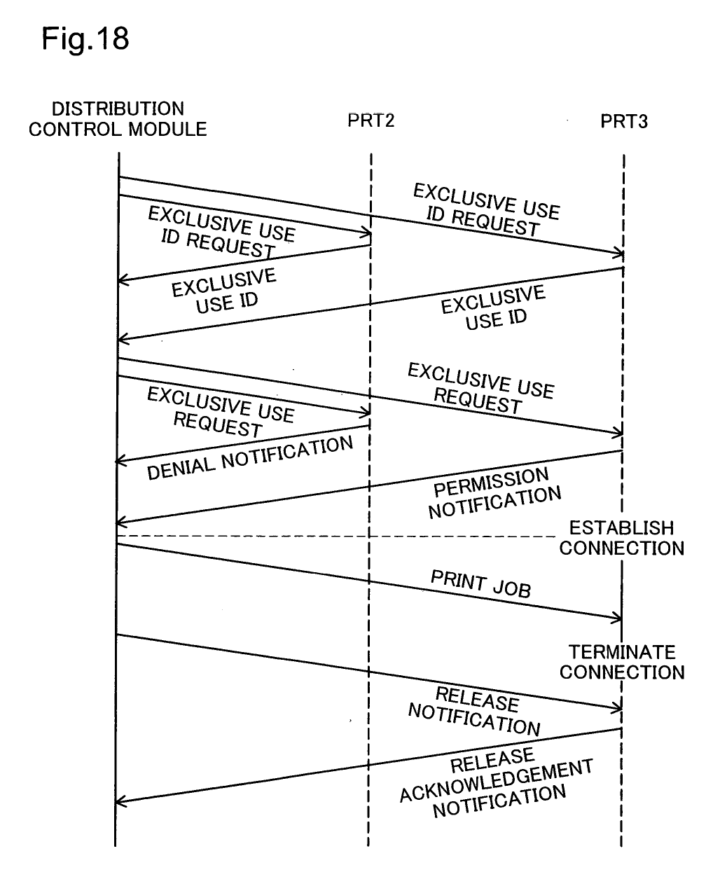

Next the communications sequence between the distribution destination printer and the distribution control module 50 of the custom network board 100 in the divided mode will be explained in reference to FIG. 18. FIG. 18 shows one example of a communications sequence in the divided mode according to the second embodiment. FIG. 18 shows the example where the printer PRT2 and the printer PRT3 are the printers selected as the distribution destination printers in the aforementioned Step S704. In FIG. 18, the arrows that start and end on the dotted lines of the horizontal lines indicating the printers PRT2 and PRT3 show the connectionless-type communications performed using SNMP. On the other hand, the arrows that start and end on the solid lines indicate connection-type communications performed using TCP.

First the exclusive use ID request is sent from the distribution control module 50 to the exclusive use permitting module 62 in each of the printers PRT2 and PRT3. The transmission of the exclusive use ID request is received directly by the exclusive use permitting module 62 without having a waiting state because of the connectionless-type communications that are performed using SNMP, as described above. After the transmission of the exclusive use ID request, the exclusive use ID is immediately sent back, as a response, from the exclusive use permitting module 62 in each of the printers PRT2 and PRT3 to the distribution control module 50.

After the exclusive use ID has been returned, the distribution control module 50 sends an exclusive use request to the exclusive use permitting module 62 in each of the printers PRT2 and PRT3. The transmission of the exclusive use request is received immediately by the exclusive use permitting modules 62, without a waiting state, because of the connectionless-type communications that are performed using SNMP in the same manner as for the exclusive use ID request. After the transmission of the exclusive use request, the permission notification or the denial notification is returned immediately to the distribution control module 50 from the exclusive use permitting module 62 in each of the printers PRT2 and PRT3 as a response.

In the example illustrated in FIG. 18, the response from the printer PRT2 is a denial notification, and the response from the printer PRT3 is a permission notification. Consequently, the distribution control module 50 establishes a connection with only the printer PRT3, which sent the permission notification, and the print job is sent to the print job receiving module 60 of the printer PRT3 through the connection that is established.

When the transmission of the print job has been completed, the connection is terminated and an exclusive use release notification is sent to the exclusive use permitting module 62 of the printer PRT3 from the distribution control module 50. After the transmission of the exclusive use release notification, the release acknowledgement notification is sent to the distribution control module 50 from the exclusive use permitting module 62 of the printer PRT3, as an immediate response, to complete the processing.

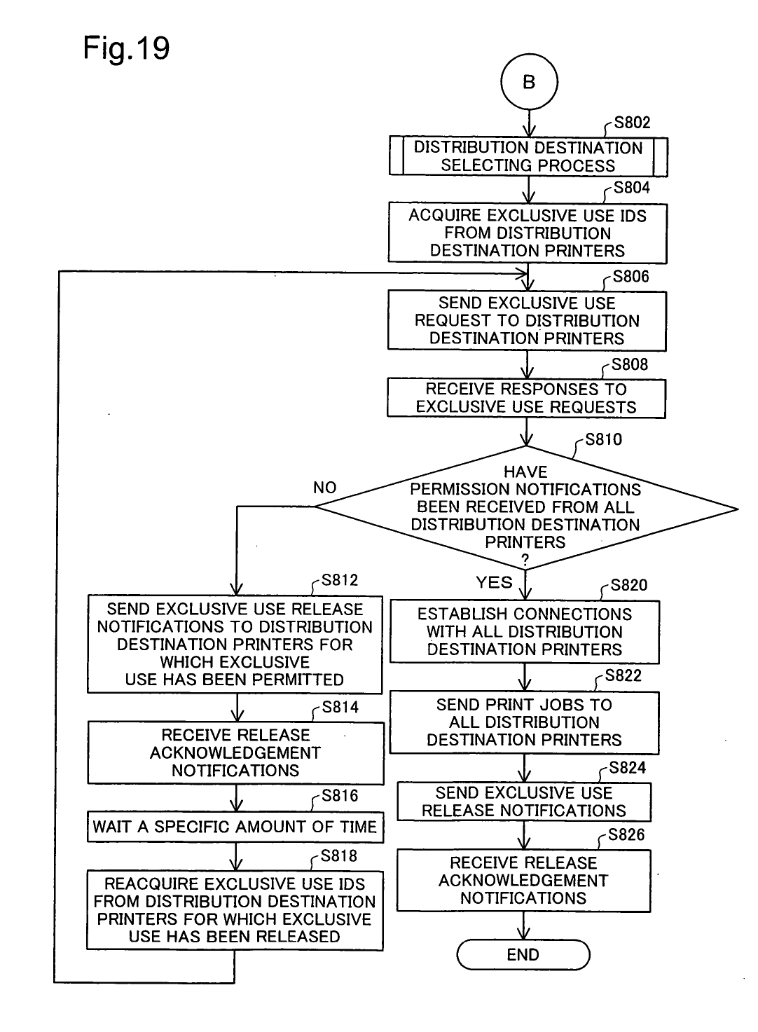

Next the process that is executed in the copy mode will be explained in reference to FIG. 19. FIG. 19 shows a second flowchart illustrating a distributed printing processing routine according to the second embodiment. The process in Step S802 is a process for selecting the distribution destination printers, and is the same process as in Step S302 of FIG. 8, explained in the first embodiment. When the distribution destination printers are selected, the receiving status determining module 54 of the distribution control module 50 acquires an exclusive use ID from each of the distribution destination printers that have been selected, using the same process as in Step S706 in the divided mode (Step S804). Next, the receiving status determining module 54 sends an exclusive use request to each of the selected distribution destination printers, using the same process as in Steps S708 and S710 in the divided mode (Step S806) to acquire a permission notification or a denial notification as a response to the exclusive use request (Step S808).

The receiving status determining module 54 determines whether or not all of the notifications from the distribution destination printers are permission notifications (Step S810). If even one of the notifications received is a denial notification (Step S810: No), then the receiving status determining module 54 sends an exclusive use release notification to the distribution destination printers for which permission notification has been received, to release, for the time being, the exclusive use of the distribution destination printers (Step S812). The result is that the notification receiving module 544 of the receiving status determining module 54 receives release acknowledgement notifications from the distribution destination printers as a response to the release notification (Step S814). Here the temporary releasing of the exclusive use of the distribution destination printers in Step S812 is for the same reason as temporarily terminating the connections with the distribution destination printers in Step S316 in the first embodiment.

Following this, the receiving status determining module 54 waits for a specific amount of time (Step S816), after which the exclusive use IDs are acquired again from the distribution destination printers for which exclusive use had been temporarily released (Step S818). Here the wait time in Step S816 uses a random number, in the same manner as in Step S318 in the first embodiment, so that the time will not always be the same. Here the wait time being determined by a random number in Step S816 is for the same reason as the wait time in Step S318 in the first embodiment being determined by a random number. After the wait time has elapsed, processing returns to Step S806, and the process described above is repeated.

When all of the notifications that have been received are permission notifications (Step S810: Yes) it is determined that the print job receiving modules 60 in each of the selected distribution destination printers are in the immediate receiving-capable state. In this state, the distribution control module 50 establishes connections with all of the distribution destination printers for sending the print job (Step S820), and sends the print job to each of the distribution destination printers through the established connection (Step S322). The transmission of the print job is performed through repeating the packet distribution PD in the same way as in the first embodiment (FIG. 10).

When the transmission of the print job has been completed, the exclusive use request module 543 sends the exclusive use release notification, described above, to all of the distribution destination printers (Step S824). The release acknowledgement notifications, sent from the distribution destination printers, are received as the response to the exclusive use release notifications (Step S826), thus completing the processing in copy mode.

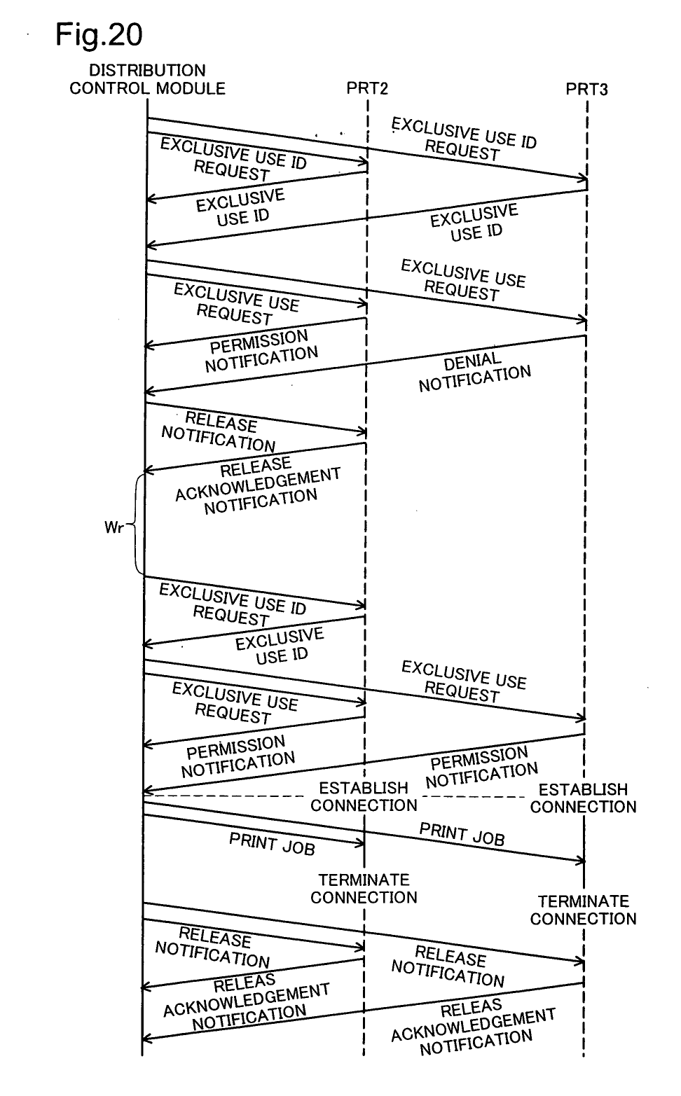

Next the communications sequence between the distribution destination printers and the distribution control module 50 of the custom network board 100 in the copy mode will be explained in reference to FIG. 20. FIG. 20 shows one example of a communications sequence in the copy mode according to the second embodiment. FIG. 20 shows an example of the case wherein the printers selected as the distribution destination printers in the aforementioned Step S802 are the printer PRT2 and the printer PRT3. In FIG. 20, as with FIG. 18, the arrows arriving and ending on the dotted lines of the vertical lines showing printer PRT2 and printer PRT3 indicate connectionless-type communications, and the arrows starting and ending on the solid lines indicate connection-type communications.

First, an exclusive use ID request is sent to the exclusive use permitting modules 62 of the printers PRT2 and PRT3 from the distribution control module 50. After the exclusive use ID request has been sent, the exclusive use ID is returned immediately in response to the distribution control module 50 from the exclusive use permitting module 62 in each of the printers PRT2 and PRT3. After the exclusive use IDs have been returned, exclusive use requests are sent from the distribution control module 50 to the exclusive use permitting module 62 in each of the printers PRT2 and PRT3. After the exclusive use request has been sent, then, as the immediate response, the permission notification or denial notification is sent from the exclusive use permitting module 62 in each of the printers PRT2 and PRT3 to the distribution control module 50.

In the example shown in FIG. 20, the response from the printer PRT2 is a permission response, and the response from the printer PRT3 is a denial response. In this case, the notifications from all of the distribution destination printers (printer PRT2 and printer PRT3) are not all permission notifications and so the exclusive use release notification is sent from the distribution control module 50 to the exclusive use permitting module 62 for the printer PRT2 in order to release, from the exclusive use state, the printer PRT2, which had permitted exclusive use. After this, a release acknowledgement notification is returned, as an immediate response, from the exclusive use permitting module 62 of the printer PRT2 to the distribution control module 50.

After this, after a specific wait time Wr has expired, an exclusive use ID request is sent to the exclusive use permitting module 62 of the printer PRT2 from the distribution control module 50. After the transmission of the exclusive use ID request, an exclusive use ID is returned, as an immediate response, to the distribution control module 50 from the exclusive use permitting module 62 of the printer PRT2, and thus the distribution control module 50 acquires an exclusive use ID again. A second round of exclusive use requests is sent to the exclusive use permitting modules 62 of each of the printers PRT2 and PRT3 from the distribution control module 50. In the second round of exclusive use requests, the exclusive use request sent to the printer PRT2 includes the exclusive use ID that was acquired again, where the exclusive use request sent to the printer PRT3 includes the same exclusive use ID as in the first round of exclusive use requests. Again, a permission notification or a denial notification is sent from the respective exclusive use permitting modules 62 of the printers PRT2 and PRT3, as responses to the distribution control module 50. In the example shown in FIG. 20, both the response from the printer PRT2 and the response from the printer PRT3 to the second round of exclusive use requests are permission notifications.

Consequently, the print job receiving modules 60 of the printer PRT2 and the printer PRT3 are both determined to be in the immediate receiving-capable state. The result is that connections are established between the distribution control module 50 and the printer PRT2 and the printer PRT3, and the print job is sent through the connections that have been established from the distribution control module 50 to the respective print job receiving modules 60 of the printer PRT2 and printer PRT3.

When the transmission of the print job has been completed, each connection is terminated, and the exclusive use release notification is sent to the respective exclusive use permitting modules 62 in the printers PRT2 and PRT3 from the distribution control module 50. After the exclusive use release notification has been sent, the release acknowledgement notification is returned as an immediate response to the distribution control module 50 from the respective exclusive use control units 62 of the printers PRT2 and PRT3.

According to the custom network board 100 pertaining to this embodiment, the print job is sent to the distribution destination printers after exclusively occupying the distribution destination printers after receiving the exclusive use permission notification, so when a print job is sent, the waiting state described above does not occur, and does not present an obstacle to the progress of the distributed printing.

Furthermore, according to the custom network board 100 pertaining to this embodiment, in the same way as in the first embodiment, makes it possible to prevent the occurrence of the deadlock described above. In the same manner as in the first embodiment, this custom network board makes it possible to achieve smooth distributed printing processes in both the divided mode and the copy mode.

In this embodiment it is necessary to provide and exclusive use permitting module 62 in order to perform processes (FIG. 14 through FIG. 16) for controlling the exclusive use of printers, as described above, but the smooth execution of the distribution process using a connectionless-type high speed communications can also achieve a smooth distributed printing process.

### C. Variations of the First and Second Embodiments

In the aforementioned first embodiment, the EJLID command is used as the determining command, but other commands may be used instead. The determining command may be: 1) a command that is received in the same manner as the case wherein the print job is received by the print job receiving module 60; 2) a command that is not received when a print job would not be received; and 3) a command that returns some sort of response when received. For example, if the command is sent through the connection that is used when sending the print job, then the conditions of 1 and 2 are fulfilled. For example, if the command is written in the language for writing at least portion of the print job data, then when sent through the connection that is used for sending the print job, preferably the command is interpreted similarly to the print job. Moreover, the command response is preferably returned immediately when the command is received and processed. Specifically, as the determining command, the EJL INQUIRE NAME or the EJL VALUE PAGESIZE command, which are written in the EJL language, just like the EJL ID command, maybe used. The EJL INQUIRE NAME command is the command for querying the printer model name, and a response including the printer model name is returned immediately upon receipt. The EJL VALUE PAGESIZE command is a command querying the size of the page that is currently selected in the printer and, immediately upon receipt, returns a response that includes the size of the page.

In the first and second embodiments, the printer controller 80 is unable to process a plurality of print jobs in parallel. Instead, the printer controller 80 may be a type capable of processing two or more print jobs in parallel. For example, the printer controller 80 may be structured so as to be able to process to print jobs in parallel, where the printing related to each print job is executed with alternating pages on the printer engine 90. In such a case, the print job receiving module 60 may be structured so as to be able to receive to print jobs in parallel through two connections. Moreover, when three or more connections are maintained, the print job receiving module 60 may receive print jobs sent through the first and second established connections, and may put into a waiting state a sending device that attempts to send a print job through the third or later established connection. In other words, when the number of print jobs that can be received in parallel by the print job receiving module 60 is less than the number of connections that can be maintained simultaneously by the TCP/IP module 10, there may be cases wherein sending devices are in a waiting state, and thus it is effective to provide a system to determine whether or not the print job receiving module 60 is in an immediate receiving-capable state, such as in first and second embodiments.

The divided mode and the copy mode, explained in the first and second embodiments, described above, are merely examples of forms of distributed printing, and the distributed printing process may be of another form instead. For example, the selection conditions for the distribution destination printers may be changed as appropriate. Specifically, when selecting the distribution destination printers in the divided mode in the first embodiment (Step S206), the condition of not currently printing may be removed from the selection conditions. Doing so makes it possible to execute the printing using the distribution destination printer that completes printing first because of responses to the determining command are sent sequentially from the distribution destination printers that have completed printing when all of the distribution destination printers that are selected are busy printing. In other words, the use of the determining command makes it possible to schedule printers that are busy printing.

In the second embodiment, described above, the method for controlling the exclusive use of a printer PRT through an exclusive use permitting module 62, provided in the printer PRT, maybe in a variety of forms. For example, the exclusive use request module 543 may send its own IP address instead of an exclusive use ID request, and, for the exclusive use request, the local IP address may be provided instead of the exclusive use ID. In such a case, the exclusive use printing module 62 may record the IP address that is sent, and the decision of a permission notification or a denial notification for the exclusive use request may be made based on the IP address included in the exclusive use request.

### D. Third embodiment

Structure of the Distributed Printing System

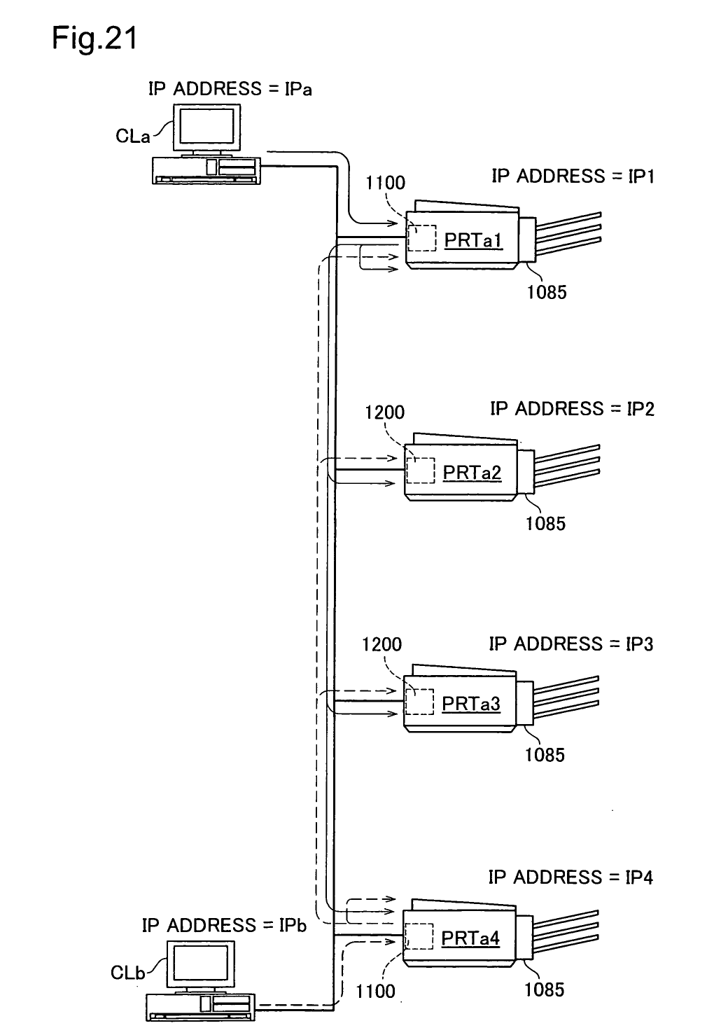

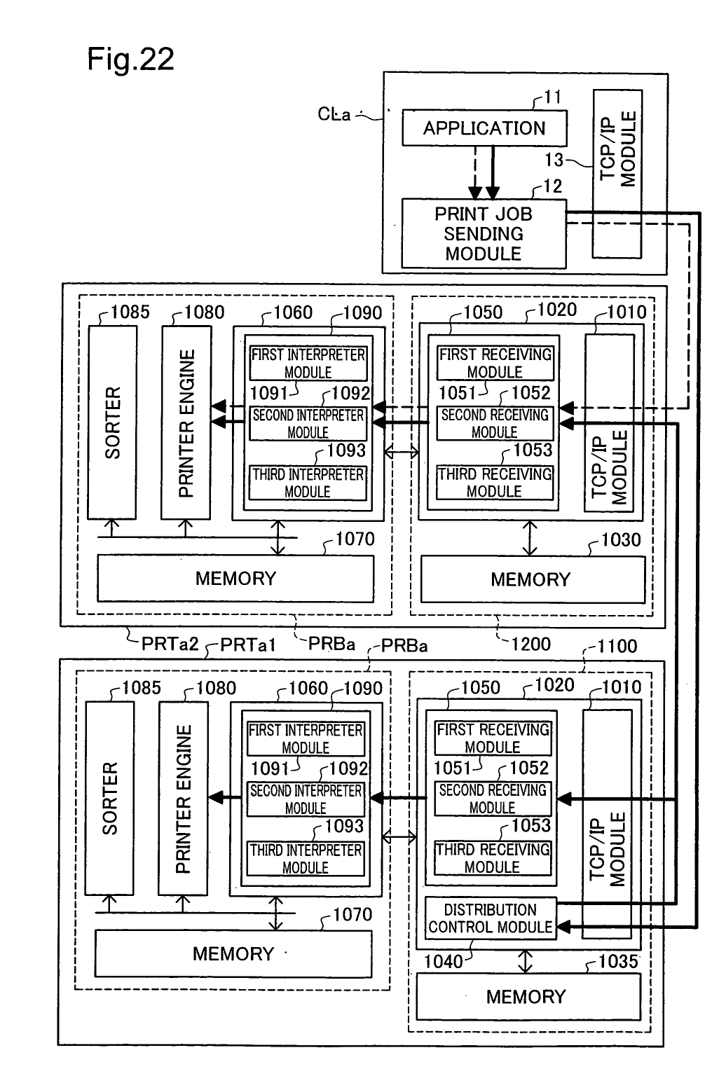

A configuration of a distributed printing system according to a third embodiment will be described in reference to FIG. 21 and FIG. 22. FIG. 21 schematically shows the configuration of a distributed printing system according to a third embodiment. FIG. 22 shows a block diagram of the internal structure of each device that structures a distributed printing system according to the third embodiment.

The distributed printing system in the third embodiment, as shown in FIG. 21, includes separate printers PRTa1 through PRTa4, instead of printers PRT1 through PRT4 in the distributed printing system according to the first embodiment (FIG. 1). Other configuration for the distributed printing system in the third embodiment are the same as configuration in the distributed printing system in the first example embodiment, and so the same codes are assigned in FIG. 21 and FIG. 22 for components that are identical to those in FIG. 1 and FIG. 2, and explanations thereof are omitted.

Of the printers in this embodiment, custom network boards 1100 are equipped in both of the printers PRTa1 and PRTa4. These custom network boards 1100 are provided with distributed printing control functions for executing distributed printing, the same as the custom network board 100 in the first embodiment. The printers PRTa2 and PRTa3 are each provided with standard network boards 1200.

The arrows shown by the solid lines in FIG. 21 show schematically the situation wherein the print job is distributed to the printers PRTa1 through PRTa4 through the custom network board 1100 of the printer PRTa1 from the client CLa, the same as in FIG. 1. Similarly, the arrows shown by the dotted lines illustrate schematically the situation wherein a print job is distributed to the printers PRTa1 through PRTa4 through the custom network board 1100 of the printer PRTa4 from the client CLb. In the below, the number at the end of the code is omitted to be simply “printer PRT” when it is not necessary to discriminate between the individual printers PRTa1 through PRTa4.

The printer PRTa1, as shown in FIG. 2 includes a printer body PRBa and a custom network board 1100, described above. The printer body PRBa includes a CPU 1060, a memory 1070, a printer engine 1080, and a sorter 1085. The CPU 1060 functions as a controller for controlling the entirety of the printer body PRBa. The memory 1070 is a memory for storing programs and data temporarily for control of the CPU 1060. The printer engine 1080 is the mechanism for performing the actual printing, and for this embodiment, this mechanism is a so-called laser-type printer engine that forms an image on the paper using phenomenon wherein toner particles are adhered through static electricity. The sorter 1085 is provided with three copy receiving trays, as storage units for storing printed paper, and equipped with a mechanism for storing the printed paper discharged from the printer engine 1080 selectively into each of the copy receiving trays.

The CPU 1060 reads out a program, such as software for controlling the printer body PRBa, from the memory 1070, and executes a program to achieve a variety of control functions in software. Note that each function may be structured in hardware instead. The functions achieved by the CPU 1060 include a job interpreter 1090. The job interpreter 1090 includes a plurality of sub-interpreter modules as sub-function blocks. In this embodiment, three sub-interpreter modules are provided, termed, respectively, the first interpreter module 1091, the second interpreter module 1092, and the third interpreter module 1093. (See FIG. 22.) The three sub-interpreter modules each interpret print jobs to generate image data, and perform an interpreting process that issues printing requests along with the image data that has been generated. These three sub-interpreter modules each function independently. The result is that the job interpreter 1090 is able to perform three interpreting processes in parallel. The printer engine 1080 receives the image data and printing requests from the 1090, and performs the printing based thereon.

The custom network board 1100 includes a CPU 1020 and a memory 1030. Note that along with these, a communications interface for performing network communications is actually provided as well, but, for convenience, the explanation thereof is omitted.

The CPU 1020 reads out a program, such as software for executing distributed printing or data communications, from the memory 1030, and executes the program to achieve, in software, the various functions that are shown. Note that the various functions may instead be structured in hardware.

The functional blocks achieved by the CPU 1020 include a TCP/IP module 1010, a distribution control module 1040, and a print job receiving module 1050. The TCP/IP module 1010 is the same as the TCP/IP module 10 in the first example embodiment, and thus the explanation thereof is omitted.

The distribution control module 1040 receives a distributed print job, wherein distributed printing is specified, and distributes the print job to the distribution destinations. The processes performed by the distribution control module 1040 are explained further below.

A print job receiving module 1050 includes a plurality of sub-receiving modules as sub-functional blocks. In the present example embodiment, three sub-receiving modules are provided, termed, respectively, the first receiving module 1051, the second receiving module 1052, and the third receiving module 1053. (See FIG. 2.) The three sub-receiving modules each receive normal print jobs, for which distributed printing is not specified, and pass the provided print jobs to the printer body PRBa. These three sub-receiving modules each function independently. The result is that the print job receiving module 1050 can receive three print jobs in parallel.

The memory 1030 not only stores a program for achieving the functions described above, but also functions as a receiving buffer for storing, temporarily, print jobs that have been received by the print job receiving module 1050.

The printer PRTa2, as shown in FIG. 2 includes a printer body PRBa and a network board 1200, described above. The structure of the printer body PRBa has the same structure as that of the printer body PRBa of the printer PRTa, described above, and so identical codes are assigned to the components that are identical to the components in the printer body PRBa of the printer PRTa1, and explanations thereof are omitted. The network board 1200 has the components of the custom network board 1100, described above, with the exception of the distribution control module 1040. In other words, the network board 1200 has a TCP/IP module 1010, a print job receiving module 1050, and a memory 1030. Each of the components of the network board 1200 has the same function and structure as the components with the same name in the custom network board 1100, and so explanations thereof are omitted.

As can be understood from the explanation above, the custom network board 1100 equipped in the printer PRTa1 and the printer PRTa4, is provided with all of the functions provided in the network board 1200 equipped in the printer PRTa2 and the printer PRTa3. So when viewed from the distribution control module 1040 of the custom network board 1100, the printers PRTa1 through PRTa4 are completely identical, and all can be designated as distribution destination printers in the distributed printing process described below. The distribution control module 1040 can treat the printer PRTa1 wherein the distribution control module 1040 itself is housed no differently from any of the other printers.

The printer PRTa4 has the same configuration as the printer PRTa1, described above, and the printer PRTa3 as the same structure as the printer PRTa2, described above. Detailed explanations thereof will be omitted.

Note that the TCP/IP module 1010 in third embodiment, as can be understood from the explanation above is equivalent to the communication module in the claim 19, the printer body PRBa is equivalent to the print executing module in the claim 19, and the printer engine 1080 is equivalent to the printing module in the claim 21.

The Distributed Printing Process

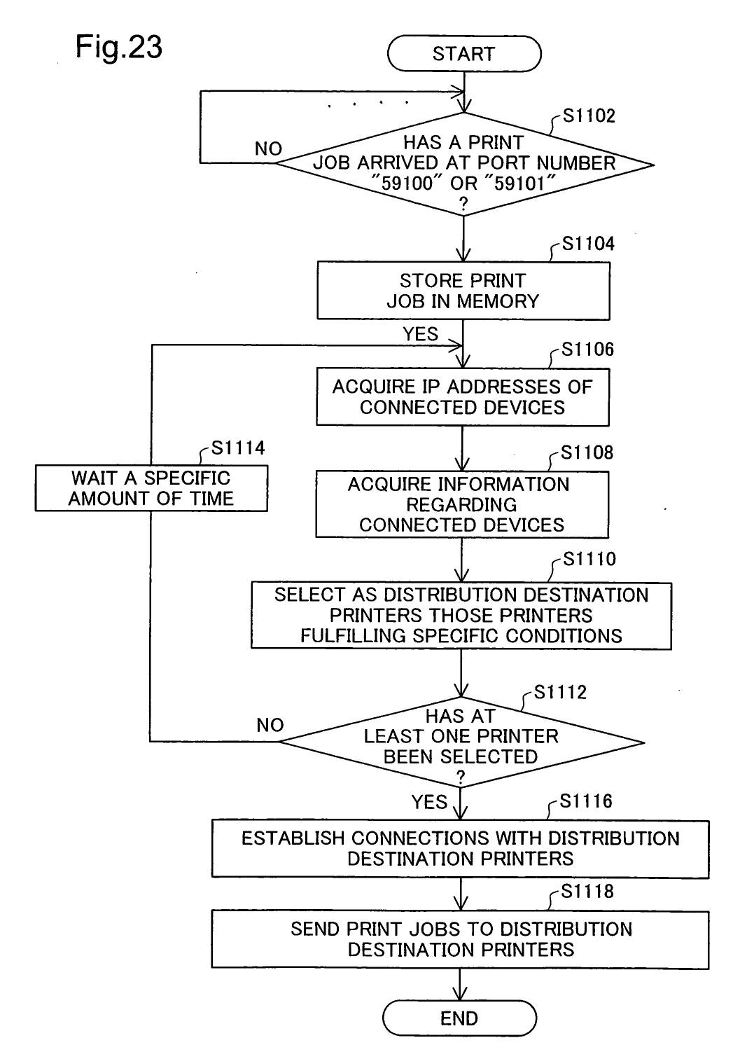

The distributed printing process in a third embodiment will be explained in detail next in reference to FIG. 23. FIG. 23 shows a flowchart illustrating a processing routine for a distributed printing process according to the third embodiment.

The distributed printing process according to the third embodiment is a process that is performed by a distribution control module 1040 that is equipped with a CPU 1020 of a custom network board 1100. The distribution control module 1040 performs printing through allocating, to distribution destination printers, a specific number of printed copies, as was the case for the first embodiment.

Print job data is sent as communication data in a format following the TCP/IP protocol, in the same manner as in the first example embodiment. The data structure of the print job data is the same as the data structure explained in reference to FIG. 3 and FIGS. 5A-C in the first embodiment, so explanations thereof are omitted, and in the explanations below, the codes from the figures will be used.

When performing the distributed printing, the user, in the printer driver of the client, sets a distribution destination port number to change from the normal “9100” to the special “59100” or “59101,” in the same way as in the first example embodiment. That which waits at the port number 9100 is the print job receiving module 1050, described above. On the other hand, that which waits at the port number 59100 or 59101 is the distribution control module 1040, described above.

The distributed printing process in the third embodiment will be explained in reference to FIG. 23. When a printer equipped with a custom network board 1100 (for example, printer PRTa1) is in a state wherein a print job can be received, the distribution control module 1040 waits until a print job arrives at port number 59100 or 59101 (Step S1102).

When communication data includes a print job (a distributed print job), for which the destination port number is designated as 59100 or 59101, arrives at printer PRTa1 from the client CL (Step S1102: Yes), the TCP/IP module 1010 transfers the print job to the distribution control module 104Q. The distribution control module 1040 stores the beginning part of the received print job (packet P1) temporarily in the memory 1030 (Step S1104).

The size of the print job data 500 will have a size that is dependent on the amount of printing in one copy. But the capacity of the memory area in the memory 1030 used to store the print job data 500 is limited. Consequently, in the same way as in the first embodiment, the print job data 500 is divided into a plurality of packet and then received (FIG. 3C). At the point in time at which the print job arrives, in Step S1102, described above, only packet P1 is received and stored in the memory 1030.

The explanation will continue, referring to FIG. 23. Next, the distribution control module 1040 executes a process (in Steps S1106 through S1114) for selecting the distribution destination printers. In the third embodiment, the processes in Steps S1106 through S1114 are identical to the distribution destination printers selecting process described in reference to FIG. 6, and so detailed explanations thereof are omitted. When explained briefly, the distribution control module 1040 uses an SNMP manager, not shown, to make a query to the SNMP agents of the printers PRTa1 through PRTa4 on the LAN, to acquire various types of information from the printers PRTa1 through PRTa4 on the LAN. The distribution control module 1040 uses the collected information to select the distribution destination printers.

When at least one distribution destination printers are selected (Step S1112: Yes), the distribution control module 1040 establishes connections with the selected distribution destination printers for sending print jobs from the distribution control module 1040 to the print job receiving modules 1050 in each of the distribution destination printers (Step S1116). Specifically, the distribution control module 1040 performs a process that establishes connections between the TCP/IP module 1010 of the custom network board 1100 and the TCP/IP modules 1010 of the distribution destination printers, in the, same manner as in the first embodiment.

The distribution control module 1040 sends the print jobs to each of the distribution destination printers through each of the connections that have been established (Step S1118). The number of copies allocated to each of the distribution destination printers is written in the job control language part 501 of the print jobs that are sent. Note that the print jobs that are sent are sent with “9100” as the destination port number. The sending of the print jobs in this step is performed through repeating the packet distribution PD (FIG. 10) multiple times, as explained in reference to FIG. 10 in the first example embodiment. For example, if the print job 500 data, shown in FIG. 5(c), is divided into 8 packets P1 through P8, the distribution control module 1040 will repeat the packet reception and the packet distribution PD of the packets received eight times, to send the print jobs to each of the distribution destination printers.

Processing in the Distribution Destination Printers

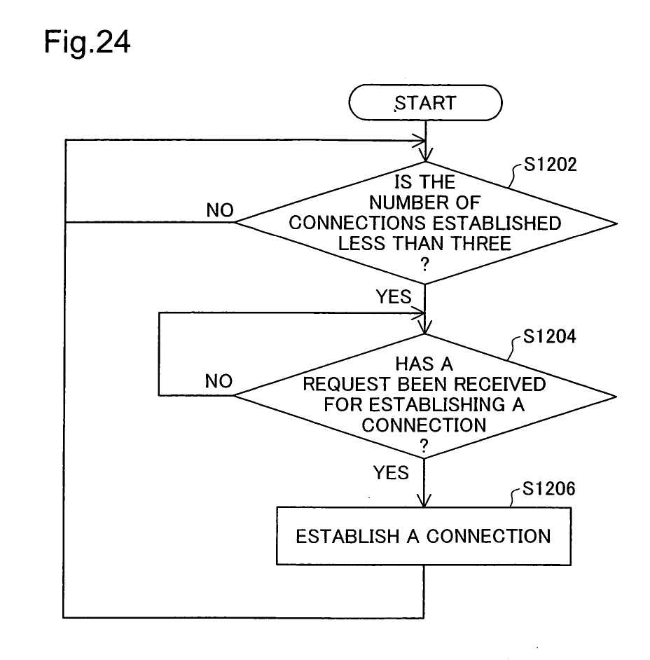

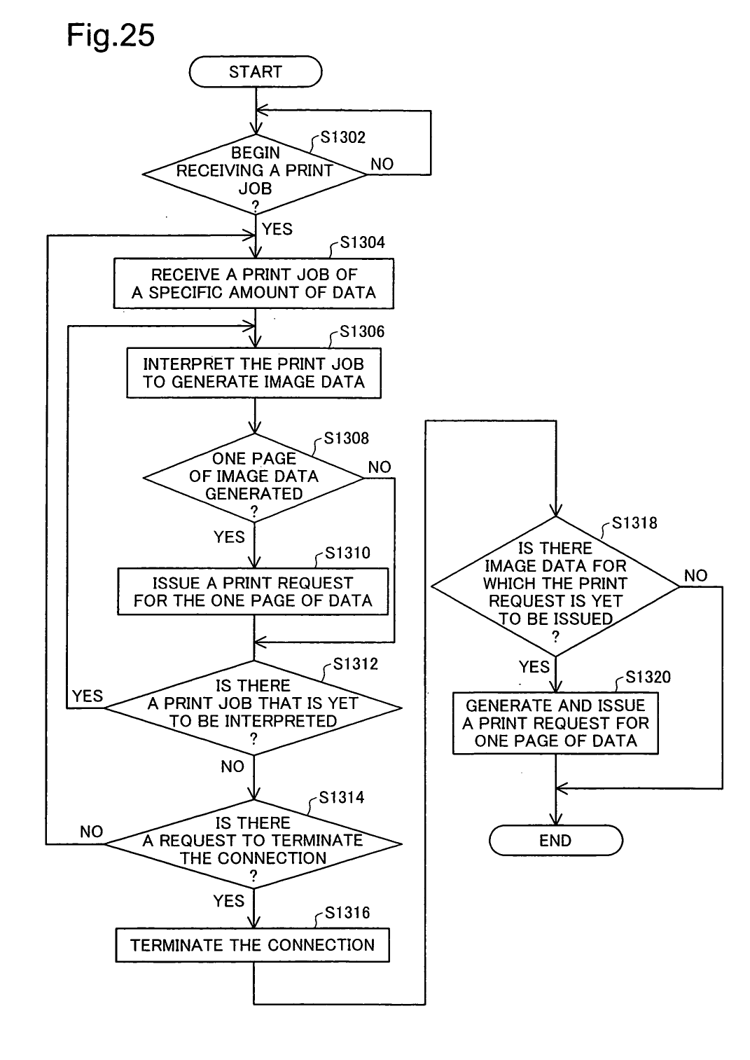

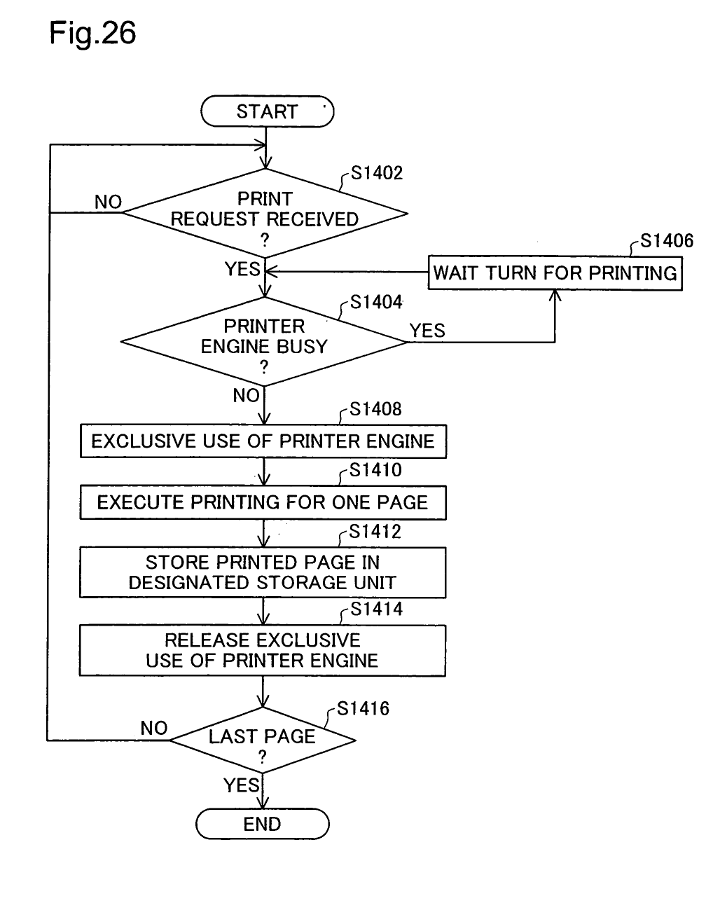

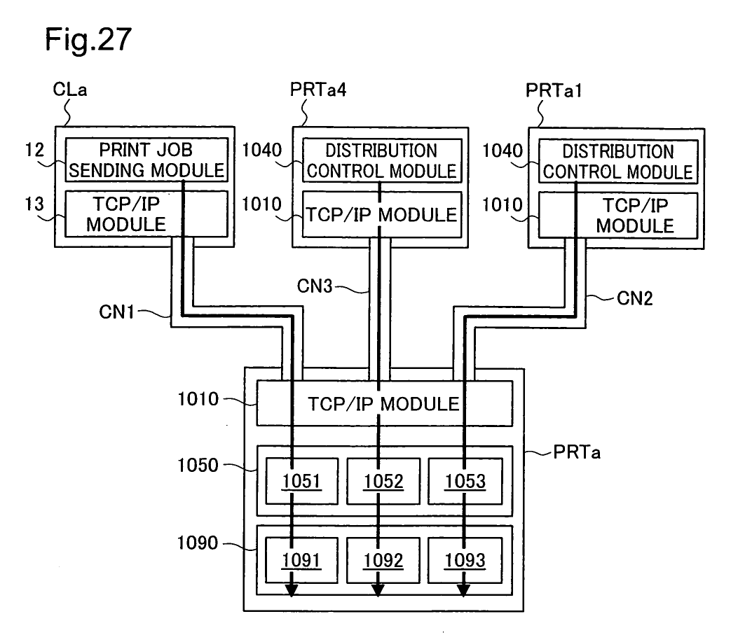

The processing in the printer PRTa as a distribution destination printer will be described next in reference to FIGS. 24 through 27. FIG. 24 shows a flowchart illustrating a processing routine for a connection establishing process according to the third embodiment. FIG. 25 shows a first flowchart illustrating a processing routine for a printing process according to the third embodiment. FIG. 26 shows a second flowchart illustrating a processing routine for a printing process according to the third embodiment. FIG. 27 shows a diagram illustrating schematically the situation wherein a plurality of printing processes is executed in parallel.

The connection establishing process, performed by the TCP/IP module 1010 of the printer PRTa, will be explained first. This connection establishing process is always performed when the power is turned ON on the printer PRTa. The TCP/IP module 1010 determines whether or not the number of connections that are currently maintained is less than three (Step S1202). If it is determined that there are already three connections (Step S1202: No), the TCP/IP module 1010 waits until the number of connections that are maintained is less than three. In other words, the TCP/IP module 1010 does not establish a new connection, so that the number of connections maintained simultaneously will not be greater than 3. The maximum number of connections that are maintained (which, in this embodiment, is “3”) is set to be the same as the number of print jobs that can be received in processed in parallel by the printer PRTa (which, in the present example embodiment, is “3”)

On the other hand, if the TCP/IP module 1010 determines that the number of connections that are currently established is less than 3 (Step S1202: Yes), then the TCP/IP module 1010 monitors the connection establishment request (Step S1204). Because a device that attempts to send a print job (the sending device) must establish a connection prior to sending the print job, the sending device must first send a connection establishment request (a SYN packet). The aforementioned custom network board 1100 (the distribution control module 1040), or the client CL is the sending device. When the TCP/IP module 1010 receives a connection establishment request (Step S1204: Yes), a connection is established for receiving the print job from the device that sent the connection establishment request (Step S1206). The TCP/IP module 1010 then returns to Step S1202.

The printing processing that is performed when the connection is established through the connection establishing process, described above, will be explained in reference to FIG. 25 and FIG. 26. When the connections are established, the print job is sent from the sending device through the connections. A receiving module, from among the first receiving module 1051 through the third receiving module 1053, which is not receiving another print job, awaits the reception of the print job (Step S1302), and when the print job is sent, receives the print job that is sent (Step S1304). The explanation will continue below assuming that the first receiving module 1051 receives the print job. The first receiving module 1051 must store the received print job in the memory 1030, and thus there is a limitation on the amount of data that can be received at one time. Because of this, the first receiving module 1051 receives the print job sequentially, starting at the beginning, in specific amounts of data that can be received at one time.

Following this, the first interpreter module 1091 interprets the print job that has been received, to thus produce image data (Step S1306). The image data that is produced is stored in the memory 1070. Next, a test is performed to ascertain whether or not one page of image data has been generated (Step S1308). Whether or not one page of data has been generated is determined based on whether or not the print job has been interpreted until the point of requiring a page break. When one page of image data has been generated (Step S1308: Yes), the first interpreter module 1091 issues a print request for the one page of generated image data (Step S1310). When a print request has been issued for one page of image data, or when one page of image data has not been generated (Step S1308: No), a test is performed to ascertain whether or not there is a print job that has been received but not been interpreted (Step S1312). If there is a print job that has not been interpreted (Step S1312: Yes), processing returns to Step S1306 in order to interpret the print job that has not yet been interpreted.

On the other hand, if there is no print job that has not yet been interpreted (Step S1312: No), then a test is performed to ascertain whether or not there is a termination request for the connection from the sending device (Step S1314). The sending device sends a connection termination request when the entirety of the print job has been sent. Consequently, when there is no connection termination request from the sending device (Step S1314: No), more of the print job is sent from the sending device, and thus processing returns to Step S1304, and the steps above are repeated (Step S1304 through Step S1312).

On the other hand, when there is a connection termination request from the sending device (Step S1314: Yes), then the print job has been received in its entirety, so the connection is terminated (Step S1316). Following this, a test is performed to ascertain whether or not there is image data for which a print request has not been issued (Step S1318). If there is no image data for which a print request has not yet been issued (Step S1318: No), then this process is terminated. On the other hand, if there is image data for which no print request has been issued (Step S 1318: Yes), then the first interpreter module 1091 issues a print request for one page worth of data for the image data for which the print request had not been issued (Step S1320), and the process is then terminated. Here, in Step S1318, the test to ascertain whether or not there is image data for which a print request has not yet been issued can be for the case wherein there is a page break request at the end of the print job, or the case wherein there is no page break request. If there is a page break request at the end of the print job, then, after the connection has been terminated, there is no image data for which the print request has not yet been issued (Step S1318: No), and the process is terminated as is. On the other hand, if there is no page break request at the end of the print job, then there will be image data, for which no print request has been issued, remaining in the memory 1070 after the connection has been terminated (Step S1318: Yes), which necessitates the process described above in Step S1320.

As described above, print requests for one page of image data are sent sequentially as the print job is received. Because there is a limit to the memory 1070 that stores the image data, this process is paused temporarily when there is no remaining space in the memory 1070. This process is restarted after the print data that has already been printed is erased when printing has been performed, in accordance with a print request for one page of image data by the process in FIG. 26, described below.

In parallel with the process shown in FIG. 25, a process that executes the printing, in accordance with a print request, is performed as shown in FIG. 26. In this process, the process waits (Step S1402) for the print request to be issued (FIG. 25: Steps S1312 and S1314), and when the print request that has been issued is received (Step S1402: Yes), then a printer engine 1080 performs a test to ascertain whether or not another print job is being printed (Step S1404). If the printer engine 1080 is currently printing another print job (Step S1404: Yes), then the printing cannot be performed immediately, so the present process waits for its turn to print the print job for the present process (Step S1406). If the printer engine 1080 is not currently printing a different print job (Step S1404: No), then the printer engine 1080 is used exclusively for the present process (Step S1408), and the printer engine 1080 performs the printing for one page of image data based on the image data that was generated in the process shown in FIG. 25 (Step S1410). For example, in the case of a print job that prints 10 copies of a 500 page document, 10 copies of the first page will be printed in the present step when the print request for the first page is received.

The paper that has been printed (a printed page) is sent to a sorter 1085, where the sorter 1085 stores the printed page in a particular copy receiving tray from among a plurality of copy receiving trays (Step S1412). The particular copy receiving tray is determined for the particular print job, where the printed pages for a single print job are stored in a single copy receiving tray. When the printing for the one page of image data has been completed, then the printer engine 1080 is released from exclusive use by the present process (Step S1414). In other words, when there is another printing process awaiting its turn to print, the exclusive use of the printer engine 1080 is transferred to the other printing process.

Following this, a decision is made as to whether or not the page that has been printed is the last page (Step S1416), and if it is determined that the page that has been printed is not the last page (Step S1416: No), then processing returns to Step S1402, and the reception of the print request for the next page is awaited. On the other hand, if it is determined that the page that has been printed is the last page (Step S1416: Yes), then the present process is complete.

The printer PRTa is able to process up to three of the printer processes, described above, in parallel. In the explanation above, the reception of the print job (Step S1302) and the print job interpreting process (Step S1304) are performed, respectively, by a first receiving module 1051 and a first interpreter module 1091. However, when a plurality of printing processes are processed in parallel, these processes are each processed independently of each other by the first receiving module 1051 and the first interpreter module 1091, the second receiving module 1052 and the second interpreter module 1092, or the third receiving module 1053 and the third interpreter module 1093, to perform the processing without any interactions between the processes. FIG. 27 illustrates the case wherein print jobs sent from three different sending devices (the client CLa, the distribution control module 1040 of the printer PRTa4, and the distribution control module 1040 of the printer PRTa1) are processed in parallel on the PRTa.

However, because the printer PRTa has only a single printer engine 1080, in the plurality of printing processes that are processed in parallel, it is necessary for the printer engine 1080 to be used exclusively. In this embodiment, the exclusive use of the printer engine 1080 is released after executing the printing of a single page in each printing process, as can be understood from the process shown in FIG. 26, described above. Doing this causes the printer engine 1080 to be used exclusively in turns by each of the printing processes, thus allowing a plurality of printing processes to move forward in parallel. In other words, the printer PRTa prints one page at a time for each of the plurality of print jobs enabling a plurality of print jobs to be processed in parallel.

In the printer PRTa in this embodiment, explained above, the number of connections maintained simultaneously for receiving print jobs is limited to no more than the number of print jobs that can be received in parallel (that is, “3” in this embodiment). The result is that if a connection is established between the sending device and the printer PRTa, the print job that is sent through the connection is certain to be received by the printer PRTa, and the sending device will not end up in the so-called waiting state.

Consequently, if the printer PRTa in this embodiment is used as the distribution destination printer in the distributed printing process, then the occurrence of deadlock (as shown in FIG. 11 and FIG. 12), described above, can be prevented in the distributed printing process.

Performing the distributed printing process with timing wherein deadlock, as described above, can occur, but using the printer PRTa according to the present of embodiment as the distribution destination printer, prevents the distribution control module 1040 that attempts to send the print job from going into the waiting state, thus preventing the occurrence of deadlock, as described above. For example, even if connections are established with the timing shown in FIG. 11, still the print job sent from the distribution control module 1040 of the printer PRTa1 and the print job sent from the distribution control module 1040 of the printer PRTa4 will be received in parallel, making it possible to execute the printing processes in parallel. Moreover, connections will not be established in excess of the number of print jobs that can be received in parallel.

Furthermore, the job interpreter 1090 of the printer PRTa in this embodiment is provided with a plurality of sub-interpreter modules (the first interpreter module 1091 through the third interpreter module 1093), enabling print jobs to be interpreted in parallel. The result is the ability to receive and quickly interpret a plurality of print jobs in parallel, expediting the printing process.

Furthermore, because for each print job the printing of one page at a time is done repetitively and a plurality of print jobs is processed, it is not necessary for the printer PRTa to receive the entirety of a print job all at once. The result is that it is possible to reduce the capacity of the memory 1030 and the memory 1070 in the printer PRTa.

Furthermore, even when a plurality of print jobs (a maximum of 3) is processed in parallel, the printed pages are separated and stored by print jobs by the sorter 1085 that is provided with three copy receiving tray. The result is the elimination of the problem of co-mingling of the printed pages from the plurality of print jobs.

### E. Variations of the Third Embodiment

The number of print jobs M that can be received in parallel by the printer PRTa is not limited to the 3 that was used to illustrate third embodiment described above. In the third embodiment, described above, the number of storage units (copy receiving trays) in the sorter 1085 is set to this same number 3; however, if a sorter that is provided with a greater number of storage units is used, then the value of M may be increased according to the number of storage units. Moreover, the number M of print jobs that can be received by the printer PRTa need not always been a constant value for a printer PRTa, but rather may be varied dynamically depending on the status of the printer PRTa. For example, the value of M may be set according to the number of those copy receiving trays in the sorter 1085 that are in a state capable of receiving printed pages. Specifically, sensors may be provided on each of the copy receiving trays of the sorter 1085 to sense whether or not the copy receiving tray contains printed pages, and the value of M can be set to the number of copy receiving trays not currently containing printed pages. In any case, the number of connections N that can be maintained simultaneously, relative to the value of M set at this time, is limited to a whole number no more than M. Doing this makes it possible to produce the operations and effects described above.

In the examples of embodiment described above, a single printer engine 1080 was provided for each printer PRTa; however, a plurality of printer engines 1080 may be provided for each printer PRTa. For example, when there are three printer engines 1080 in a single printer PRTa, one printer engine 1080 may be assigned to each of the three sub-interpreter modules (the first interpreter module 1091 through the third interpreter module 1093), making it possible to execute the printing processes even more quickly.

In third embodiment described above, when a plurality of print jobs is processed in parallel, each print job repetitively prints one page at a time; however, the unit for repetition is not limited to one page at a time. For example, two pages or three pages may be repeated at a time. This makes it possible to modify the amount of image data that is stored at one time depending on, for example, the capacity of the memory 1070.

The printer engine 1080 in third embodiment described above can use a variety of different types of printer engines. For example, the printer engine is not limited to being of a laser printer type, but rather may use printer engines of all different types including, for example, the inkjet type, the dye-sublimation type, the dot impact type, the thermal transfer type, and so forth.

While the printing control device, the printer and method pertaining to the invention have been shown and described on the basis of the embodiments and variations, the embodiments of the invention described herein are merely intended to facilitate understanding of the invention, and implies no limitation thereof. Various modifications and improvements of the invention are possible without departing from the spirit and scope thereof as recited in the appended claims, and these will naturally be included as equivalents in the invention.

What is claimed is:

1. A printing control device capable of sending print jobs to at least two distribution destination printers respectively, the distribution destination printers respectively having: a printing module that executes the printing in accordance with a provided print job; a first communication module that performs communication using a connection-type protocol, wherein the first communication module is capable of maintaining simultaneously a plurality of the connections for the communication; and a job receiving module that receives the print job through the connection to provide the received print job to the printing module, wherein the connections from which the job receiving module is able to receive data in parallel is less than the connections that the first communication module is able to maintain simultaneously, wherein the job receiving module receives with priority data that is sent through the connection that was established in advance when the first communication module maintains the connections in excess of a receivable number in parallel;
the printing control device comprising:
a second communication module that establishes the connections with each of the first communication modules of the at least two distribution destination printers;
a status determining module that determines whether each of the job receiving modules of the at least two distribution destination printers is in a receiving-capable state in which the job receiving module is immediately able to receive data sent through the connection established by the second communication module; and
a job sending module that transmits the print job to the distribution destination printer having the job receiving module being determined to be in a receiving-capable state.

2. A printing control device according to claim 1,
wherein the job sending module divides the print job into a plurality of packets and repetitively executes, for each of the divided packets, packet distribution; and
wherein the packet distribution is sending one of the packets to the respective at least two distribution destination printers to send the print job to the respective at least two distribution destination printers.

3. A printing control device according to claim 2,
wherein the printing control device receives the print job for each of the packets from a computer that is connected to the printing control device; and
wherein the printing control device receives from the computer the packet to be sent next, after confirming that each of the packets has been sent by the job sending module to each of the at least two distribution destination printer.

4. A printing control device according to claim 1, wherein
the printing control device used in a distributed printing system that includes the at least two printing controlling devices and at least two distribution destination printers that can be specified as the print job distribution destinations for the at least two printing controlling devices respectively.

5. A printing control device according to claim 1,
wherein said printing control device is used in a distributed printing system that includes the at least two distribution destination printers and the at least two printing control devices; and
wherein said distributed printing system is able to form a closed loop connecting the at least two distribution destination printers and the at least two printing control devices through the connections that are established between the first communication modules and the second communication modules.

6. A printing control device according to claim 1,
wherein said status determining module comprises:
a command sending module that sends commands requesting responses to the distribution destination printers respectively; and
a response receiving module that receives response to the commands from the distribution destination printer; and
wherein the status determining module determines whether the job receiving module is in the receiving-capable state depending on the response to the command.

7. A printing control device according to claim 6,
wherein the command is sent to the job receiving module through the established connection and is received by the job receiving module when the job receiving module is in said receiving-capable state;
wherein the response to said command is returned through the connection used in the transmission of the command, when the command has been received by the job receiving module; and
wherein the status determining module determines that the job receiving module is in the receiving-capable state when a response to said command has been received.

8. A printing control device according to claim 7, wherein
the job sending module sends the print job through the connection used to receive a response to the command.

9. A printing control device according to claim 7, wherein
the command is written using a language for describing at least a part of the print job.

10. A printing control device according to claim 6,
wherein the command is an exclusive use request for requesting, to said distribution destination printer, exclusive use of the distribution destination printer;
wherein a response to the command is either a permission notification that is sent to the printing control device in response to the exclusive use request when exclusive use of the distribution destination printer is permitted, or a denial notification that is transmitted when exclusive use is not permitted; and
wherein the status determining module determines that the job receiving module is in the receiving-capable state when said permission notification has been received.

11. A printing control device according to claim 10, wherein
the transmission and reception of the exclusive use request, the permission notification, and the denial notification are performed using a connectionless communication protocol.

12. A printing control device according to claim 1 further comprising a distribution destination selecting module that selects, as the distribution destination printer, a printer fulfilling specific conditions from among printers that are connected to the printing control device;
wherein the status determining module determines whether the job receiving module for the selected distribution destination printer is in the receiving-capable state; and
the job sending module sends the print job to a specific printer among the selected distribution destination printers, wherein the specific printer is a printer determined to be in said receiving-capable state within a specific time period.

13. A printing control device according to claim 1 further comprising a distribution destination selecting module that selects, as said distribution destination printer, at least two printers fulfilling specific conditions from among printers that are connected to the printing control device;
wherein the status determining module repetitively performs a process for determining whether the job receiving modules for the selected distribution destination printers is in the receiving-capable state until all of the job receiving modules for all of the selected distribution destination printers are determined to be in the receiving-capable state; and
wherein the job sending module sends a print job to all of the selected distribution destination printers when all of the job receiving modules for all of the selected distribution destination printers have been determined to be in the receiving-capable state.

14. A printing control device according to claim 1, wherein
the printing control device is housed within any of printers connected to the printing control device.

15. A printing control device according to claim 14, wherein
a printer in which the printing control device is housed is permitted to be assigned as the distribution destination printer.

16. A printer that houses a printing control device according to claim 1.

17. A print job sending method capable of sending print jobs to at least two distribution destination printers respectively, the distribution destination printers respectively having: a printing module that executes the printing in accordance with a provided print job; a first communication module that performs communication using a connection-type protocol, wherein the first communication module is capable of maintaining simultaneously a plurality of the connections for the communication; and a job receiving module that receives the print job through the connection to provide the received print job to the printing module, wherein the connections from which the job receiving module is able to receive data in parallel is less than the connections that the first communication module is able to maintain simultaneously, wherein the job receiving module receives with priority data that is sent through the connection that was established in advance when the first communication module maintains the connections in excess of a receivable number in parallel;
the print job sending method comprising:
establishing the connections with each of the first communication modules of the at least two distribution destination printers;
determining whether each of the job receiving modules of the at least two distribution destination printers is in a receiving-capable state in which the job receiving modules is immediately able to receive data sent through the connection established by the second communication module; and
transmitting the print job to the distribution destination printer having the job receiving module being determined to be in a receiving-capable state.

18. A computer readable medium comprising computer program code capable of sending print jobs to at least two distribution destination printers respectively, the distribution destination printers respectively having: a printing module that executes the printing in accordance with a provided print job; a first communication module that performs communication using a connection-type protocol, wherein the first communication module is capable of maintaining simultaneously a plurality of the connections for the communication; and a job receiving module that receives the print job through the connection to provide the received print job to the printing module, wherein the connections from which the job receiving module is able to receive data in parallel is less than the connections that the first communication module is able to maintain simultaneously, wherein the job receiving module receives with priority data that is sent through the connection that was established in advance when the first communication module maintains the connections in excess of a receivable number in parallel;
the computer program code implementing the following procedures:
establishing the connections with each of the first communication modules of the at least two distribution destination printers;
determining whether each of the job receiving modules of the at least two distribution destination printers is in a receiving-capable state in which the job receiving module is immediately able to receive data sent through the connection established by the second communication module; and
transmitting the print job to the distribution destination printer having the job receiving module being determined to be in a receiving-capable state.

19. A printer comprising:
a communication module that maintains connections to perform communication using a connection-type protocol;
a job receiving module that receives print jobs through the connections, wherein the number of the print jobs that are able to received in parallel is M, wherein the M is a natural number; and
a print executing module that executes printing processes in parallel for the received print jobs;
wherein the number of connections that is maintained simultaneously by the communication module is set to be less than the M.

20. A printer according to claim 19,
wherein the printer is connected to a printing control device capable of sending at least one of the print jobs to at least two distribution destination printers respectively, wherein the printing control device divides at least one of the print jobs into a plurality of packets and repetitively executes, for each of the divided packets, packet distribution, wherein the packet distribution is sending one of the packets to the respective at least two distribution destination printers to send the print job to the respective at least two distribution destination printers; and
wherein the printer used as one of the distribution destination printers.

21. A printer according to claim 19,
wherein the print executing module comprises:
a job interpreter that executes an interpreting process interpreting said received print job to generate a print request, wherein the job interpreter is capable of executing the interpreting process in parallel for the M print jobs; and
a printing module that outputs the printing results of the print job based on the printing request that has been generated.

22. A printer according to claim 21, wherein
the printing module outputs the printing results of a plurality of the print jobs through repetitively outputting the printing results of each print job a specific number of pages at a time.

23. A printer according to claim 22 further comprising a sorter that divides and stores the printing results outputted by said printing module into a plurality of storage units for each of said print jobs.

24. A printer according to claim 23, wherein
the number M of print jobs that are able to be received in parallel is the number of storage units possessed by the sorter.

25. A printer according to claim 19, wherein
the number M of print jobs that are able to be received in parallel varies depending on the status of the printer.

26. A printer according to claim 23, wherein
the number M of print jobs that are able to be received in parallel is the number of storage units in a state capable of receiving printing results among the storage units of the sorter.

27. A printer according to claim 21 comprising the M printing modules.

28. A printing method comprising:
maintaining connections upon request to perform communication using a connection-type protocol, wherein the number of the connections maintained simultaneously is less or equal N, wherein the N is a natural number;
receiving print jobs in parallel, the print jobs being sent through each of the maintained connections; and
executing printing processes in parallel for the print jobs received in parallel;
wherein the N is less than M, the M is a receivable print job number in parallel.

29. A computer readable medium storing a computer program for control a printer, the computer program comprising:
a program instruction for maintaining connections to perform communication using a connection-type protocol;
a program instruction for receiving print jobs through the connections, wherein the number of the print jobs that are able to received in parallel is M, wherein the M is a natural number; and
a program instruction for executing printing processes in parallel for the received print jobs;
a program instruction for setting the number of connections that is maintained simultaneously to be less than the M.
